(19) United States
(12) Patent Application Publication
(10) Pub. No.: US 2005/0048960 A1
(43) Pub. Date: Mar. 3, 2005

(54) Information processing device, control device, communication device, communication equipment, electronic device, information processing system, power management method, power management program, and recording medium

(75) Inventors: Masahiro Yamauchi, Chiba-shi (JP); Tsuguhiro Aoki, Tenri-shi (JP); Tetsuo Ueno, Funabashi-shi (JP); Shigetaka Noguchi, Inashiki-gun (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka (JP)

(21) Appl. No.: 10/918,423

(22) Filed: Aug. 16, 2004

Related U.S. Application Data
(60) Provisional application No. 60/587,545, filed on Jul. 14, 2004.

(30) Foreign Application Priority Data
Sep. 3, 2003 (JP) 2003-310872
Feb. 27, 2004 (JP) 2004-054226
Jul. 2, 2004 (JP) 2004-197369

(51) Int. Cl. H04Q 7/20

(52) U.S. Cl. 455/418; 455/522

(57) ABSTRACT

A system controller is provided between a communication device and an electronic device which performs communication using the communication device. The system controller controls the communication device, in accordance with device information from the electronic device, a request from the application, and channel information from the communication device. With this arrangement, the communication device can realize an effective low-power-consumption operation, while having a high degree of versatility.

This Nonprovisional application claims the benefit of U.S. Provisional Application No. 60/587,545 filed on Jul. 14, 2004, and claims priority under 35 U.S.C. § 119(a) on Patent Application No. 2004/197369 filed in Japan on Jul. 2, 2004, Patent Application No. 2004/54226 filed in Japan on Feb. 27, 2004, and Patent Application No. 2003/310872 filed in Japan on Sep. 3, 2003, the entire contents of which are hereby incorporated by reference.

### FIELD OF THE INVENTION

The present invention relates to technology to control a communication device and an electronic device associated with the communication device, and more particularly to technology to reduce amounts of power consumed by these devices. The present invention also relates to a system to control a device including the communication device.

### BACKGROUND OF THE INVENTION

Mobile terminals such as mobile personal computers (hereinafter, mobile PCs), PDAs (Personal Digital Assistants), and mobile phones have become very popular and have actively been developed. It is worth noting that wireless communication capability has become one of the must-have features of mobile terminals. Nowadays not only mobile PCs and PDAs but also some types of mobile phones support high-speed communication capability such as wireless LAN.

Performing wireless communications generally requires a lot of power. Meanwhile, mobile equipments are typically battery-operated, so that power management is a matter of importance. In other words, th reduction of power consumption is one of the most important issues in communication devices, in particular mobile terminals such as mobile phones that are frequently carried around.

There has conventionally been a proposition of an information processing device in which resumption is performed when a wireless communication section detects a signal for activating a resuming function, the signal being included in a received signal (e.g. Japanese Laid-Open Patent Application No. 2002-341975 (Tokukai 2002-341975; published on Nov. 29, 2002)). With this, the conditions of the resumption can be flexibly changed, so that a user-friendly device is provided.

There has been another proposition of an information processing device including control means by which communications with a mobile phone is automatically performed irrespective of the operating state of a CPU (cf. Japanese Laid-Open Patent Application No. 2002-312300 (Tokukai 2002-312300; published on Oct. 25, 2002)). This realizes wireless data communication with fewer amounts of power and in a user-friendly fashion.

A typical technique for the reduction of power consumption is discussed with reference to FIG. 27. FIG. 27 is a block diagram showing an example of a typical mobile phone. In the figure, dotted arrows indicate the flows of audio/non-audio data, while full-line arrows indicate the flows of a control signal. In a normal operating state, data generated by an application 740 in a mobile phone 700 is supplied to an RF section 710 via a MAC section 730 and a BB section 720. The supplied data is then converted to a wireless signal in a Tx2 section 712 and a TX1 section 713 of the RF section 710, and dispatched from an antenna 714. In the meanwhile, a received wireless signal is demodulated to received data in an Rx1 section 711 of the RF section 710 and the BB section 720, and then supplied to the application 740 via the MAC section 730.

When a device information section 750 receives a signal which indicates, for instance, “battery power of the mobile phone 700 is low”, a power management section 770 turns off, for instance, the Tx2 section 712 of the RF section, in order to reduce the power for transmission. Furthermore, an operation control section 731 of the MAC section 730 controls the operation of the communication circuit in such a manner as to lengthen waiting intervals of intermittent reception. By these controls, the power consumption concerning the mobile phone communications is reduced, and hence the batter life is extended.

Meanwhile, there are communication devices such as wireless LAN equipments, which are always used in conjunction with electronic equipments such as personal computers (hereinafter, PCs) and PDAs. Since such a communication equipment solely provides a wireless communication function, it is difficult to reduce the power consumption by the cooperation of the whole equipment as in the case of mobile phones.

FIG. 28 shows an example that a wireless LAN equipment is connected to an information equipment such as a PC. In the figure, dotted arrows indicate the flows of communication data, while full-line arrows indicate the flows of a control signal. In this example, a wireless LAN equipment 500 solely carries out the control for wireless communications, so that the control for the reduction of power consumption is performed in such a manner that an equipment control section 620 provided in an information equipment 600 controls an operation control section 531 provided in a MAC section 530 in the wireless LAN equipment 500 (see, for example, Japanese Laid-Open Patent Application No. 2003-15783 (Tokukai 2003-15783; published on Jan. 17, 2003)).

To effectively reduce the power consumption of purpose-built communication equipments such as mobile phones, the circuitry and control sequence are designed in consideration of the intended use, properties, and functions of the whole equipment, with the assumption that a wireless communication section is an integral part of the whole equipment.

On the other hand, in the case of equipments which solely provide a wireless LAN function and are adopted to an information equipment of the user's choice, e.g. a wireless LAN device, importance has to be placed on versatility. For this reason, unlike mobile phones, it is not possible to carry out the sophisticated control or adopt special circuitry, and hence the above-described equipments cannot include anything more than the minimum-required mechanism.

For instance, being battery-operated, note PCs which have to excel in portability are required to consume a relatively few amounts of power. To the note PCs, not only a wireless LAN equipment but also other communication devices and a hard disk are connected. Since such devices to be connected also have a minimum-required mechanism, the power consumption cannot be reduced more than a certain limit. To reduce the power consumption of this case, for instance, Japanese Laid-Open Patent Application No. 2003-15783 (Tokukai 2003-15783; published on Jan. 17, 2003) teaches that the power consumption is reduced by estimating the hours of use of connected devices and turning off those devices when not in use.

However, the above-described device being connected does not always operate even if the device is supposed to be in operation. Minute investigation of the operation of the device uncovers a lot of non-operation periods. To reduce the power consumption, there is such an idea of subtle power management between the note PC and the connected device. To carry out the subtle power management, however, the connected device has to include a specially-constructed circuit, as in the case of the above-mentioned wireless LAN equipment.

General-purpose devices such as wireless LAN equipments are designed to have general-purpose circuitry and control sequence, in consideration of connectivity with various types of electronic devices, and manufacturing costs thereof is restrained on account of volume efficiency. These characteristics of the general-purpose devices, however, hamper effective reduction of power consumption. For instance, to create a domestic LAN network, it is preferable that information equipments such as a PC and a PDA, AV equipments such as a television, a video, and an audio equipment, and communication devices such as a cordless phone are connected to each other under one communication protocol.

The connection between these devices are typically done under the internet protocol (IP), in a wired or wireless manner. Since a wired connection in a house is annoying and adding or replacing wires is tiresome, a wireless connection is often preferred. Also from a cost point of view, it is preferable that wireless LAN cards for wireless communication are provided to the respective devices. However, dealing with different types of applications, a PDA, a cordless phone, and a television require different types of communication control concerning wireless LAN. The PDA requires communication only when needed, e.g. when receiving a mail or downloading data. The cordless phone requires continuous intermittent reception in order not to miss an incoming call, and also requires bandwidth guarantee because voices should be transmitted without delay and interruption. As to the television, since not only sounds but also images have to be reproduced, it is necessary to guarantee a wider data bandwidth. Moreover, the time for communication is longer than the time in the cordless phone, so that larger amounts of power are consumed.

Meanwhile, although electric power consumed by a backlight of an LCD is almost negligible in the cordless phone, such power consumption plays a great role in the PDA which is required to have a large display device. A battery-operated television has a larger display device, so that the reduction of the power consumption is demanded in a more rigorous fashion.

In this manner, it is desired to provide, to the respective devices, communication devices suitable for the characteristics of the respective devices, because the communication control methods in the most frequently-used condition and the conditions and times when the power consumption is restrained differ between the devices. However, developing ad-hoc communication devices is costly. That is to say, a communication device consuming a few amount of power can be realized by designing circuitry in accordance with the characteristics of the device and the conditions of use, and providing a controlling process. However, such communication device is costly. In the meanwhile, a multi-purpose wireless equipment is inexpensive thanks to volume efficiency, but the power consumption cannot be reduced more than a certain limit, because the circuitry and controlling process cannot be specialized.

An electronic device may have a plurality of applications, and more than one application may simultaneously run.

The prior art disclosed by the document above (Japanese Laid-Open Patent Application No. 2002-341975 or Japanese Laid-Open Patent Application No. 2002-312300) does not take into consideration the situation that a plurality of applications run in one mobile equipment (electronic device). In reality, mobile PCs, PDAs, and mobile phones are significantly improving in the processing power, so that many of these equipments sufficiently have multitasking capability.

In the above-mentioned case, an equipment including a wireless transmission circuit (communication device) is arranged such that a plurality of applications such as a mailer, web-accessing program, VoIP (Voice over IP) program, and stream receiver use said one wireless transmission circuit simultaneously or at different timings.

Referring to FIG. 29, the following will discuss how the wireless transmission circuit for applications is used and problems associated with the processing of the applications on the occasion of performing power saving. FIG. 29 schematically depicts such a case that a user 1001 uses an equipment 1003. As shown in FIG. 29, various types of applications can run on the equipment 1003. Examples of these applications are four different types of software: a mailer 1005, a web-browsing program 1007, a VoIP program 1011, and a streaming media player 1015.

The mailer 1005 is regularly activated at, for instance, one-minute intervals, in order to check the presence or absence of an incoming mail, so as to use the wireless transmission circuit 1017. When there is an incoming e-mail, the wireless transmission circuit 1017 is continuously used until finishing the transmission of the mail data.

Upon the instruction from the user, the web-browsing program 1007 continuously transmits web-browsing data, using the wireless transmission circuit.

Upon the instruction from the user, the streaming media player 1015 continuously receives streaming data at predetermined intervals, using the wireless transmission circuit.

The VoIP program 1011 has to regularly perform transmission at relatively short intervals, e.g. at 20 ms-intervals. The operating time of the wireless transmission circuit for one transmission is significantly shorter than the times for data transmissions in the above-mentioned applications.

In this manner, when a common wireless transmission circuit 1017 is used by different types of applications having different characteristics in terms of the conditions of use, in particular, when a power saving function 1018 of the wireless transmission circuit 1017 is used, problems inherent to respective applications occur. Examples of such problems include incomplete mail exchange, slow answering time, degradation of streaming quality, and the occurrence of delay.

These problems are particularly associated with how the power saving is performed while more than one application runs (in the case of multitasking). When, meanwhile, only one application runs, a problem inherent to the application may occur.

### SUMMARY OF THE INVENTION

The objective of the present invention is to provide an information processing device which allows a communication device to have versatility and realizes an effective low-power-consumption operation of the communication device. The objective of the present invention is also to provide a technique to smoothly carry out power saving of the communication device, without causing problems inherent to application software, such as incomplete e-mail reception, slow response, degradation of the quality of streaming, and delay time.

To achieve these objectives, the information processing device of the present invention is characterized by comprising: a communication device; an electronic device which executes at least one application; and a control device which determines a control signal supplied to the communication device, in accordance with first information supplied from the electronic device.

According to this arrangement, in addition to the communication device and the electronic device, the control device for controlling the communication device is provided. With this, the application does not necessarily include a special program for controlling electric power of the communication device. Furthermore, since the communication device is controlled by the control device in accordance with the first information (e.g. information indicating whether or not the application is in operation) supplied from the control device, the communication device is highly versatile and thus can be adopted to different types of electronic devices. For this reason, even a multipurpose communication device which can be manufactured at low costs thanks to volume efficiency can realize a low-power-consumption operation most appropriate to a use environment of the device.

For a fuller understanding of the nature and advantages of the invention, reference should be made to the ensuing detailed description taken in conjunction with the accompanying drawings.

### BRIEF DESCRIPTION OF THE DRAWINGS

FIG. 1 shows an example of a profile controller of an embodiment of the present invention.

FIG. 2 outlines the operations performed among the profile controller of the embodiment, an electronic device, and a communication device.

FIG. 3 is a flow chart illustrating the operation of the profile controller of the embodiment.

FIG. 4 shows an example of a communication equipment including the profile controller of the embodiment.

FIG. 5 shows an example of a control profile table included in a profile selecting section.

FIG. 6 shows another example of the control profile table.

FIG. 7(a) shows an example of an instruction from a control profile selected from the control profile table.

FIG. 7(b) illustrates what is instructed to a communication circuit.

FIG. 7(c) schematically shows the communication operation of the communication circuit controlled by the profile controller.

FIG. 8(a) is an example of an instruction from a control profile selected from the control profile table.

FIG. 8(b) illustrates what is instructed to a communication circuit.

FIG. 8(c) schematically shows the communication operation of the communication circuit controlled by the profile controller.

FIG. 9 is referred to on the occasion of making a selection with reference to the control profile table, and shows an example of the relationship between the priority (weighting coefficient) of an application and a remaining battery resource.

FIG. 10(A) illustrates the versatility of a conventional communication device.

FIG. 10(B) illustrates the versatility of the communication device of the embodiment.

FIG. 11 outlines power saving performed in a wireless transmission circuit (communication device) of another embodiment of the present invention.

FIG. 12 illustrates an example of configuration of a device management system of another embodiment of the present invention.

FIG. 13 shows an example of a wireless transmission circuit.

FIG. 14 shows a list of operation modes of the wireless transmission circuit.

FIG. 15 illustrates an example of the operation in a first step of a power management determination circuit.

FIG. 16 illustrates an example of the operation in a second step of the power management determination circuit.

FIG. 17 outlines processes concerning the wireless transmission circuit.

FIG. 18 shows an example of a power saving operation (constant beacon interval operation) of the wireless transmission circuit.

FIG. 19 shows an example of the power saving operation (constant beacon interval operation) of the wireless transmission circuit.

FIG. 20A shows an example of a power saving operation (pre-selection receiving operation) of the wireless transmission circuit.

FIG. 20B shows a pre-selection reception setting sequence.

FIG. 21 shows an example of a power saving operation (off-control operation) of the wireless transmission circuit.

FIG. 22 illustrates the relationship between the operation of an application and the power management in the embodiment of the present invention, and also shows how commands are controlled.

FIG. 23 provides details of the operation in a period A in FIG. 22.

FIG. 24 provides details of the operation in a period B in FIG. 22.

FIG. 25 provides details of the operation in a period C in FIG. 22.

FIG. 26 provides details of the operation in a period D in FIG. 22.

FIG. 27 is a block diagram showing an example of a typical mobile phone.

FIG. 28 is a block diagram of an example of a typical wireless LAN equipment.

FIG. 29 schematically illustrates how the user uses a device on which a plurality of applications can run.

### DESCRIPTION OF THE EMBODIMENTS

### Embodiment 1

In this specification, “application” indicates a program which has a user interface and runs on an electronic device, such as a mailer for exchanging e-mails and a web-browser for browsing web sites. “Electronic device” indicates a device which operates in accordance with the application. Examples of the electronic device includes note PCs, PDAs, cordless phones, and home electric appliances including microcomputers. “Communication device” is a device with communication (e.g. data communication) capability. The communication device operates in conjunction with the electronic device and can provide the communication capability to the electronic device. “Control profile” indicates the state of control concerning communication in a particular condition. “Control profile table” is a table which allows the communication device to choose an optimum control profile, in accordance with various types of information obtained from hardware and software which are directly or indirectly connected to the communication device.

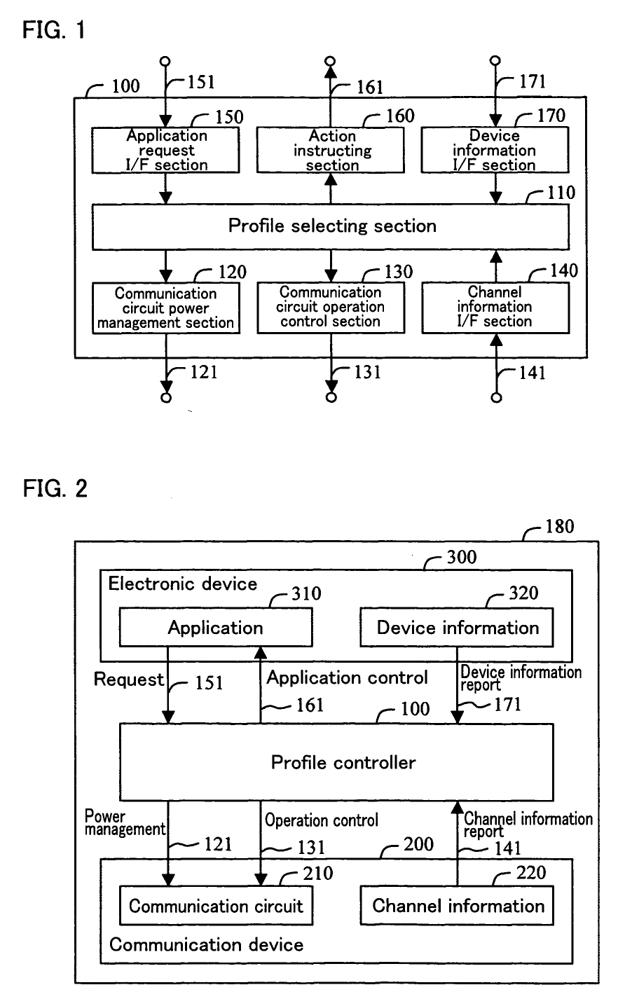

FIG. 1 shows an example of a profile controller (control device) of an embodiment of the present invention. As in the figure, the profile controller 100 of the present embodiment includes a profile selecting section 110 and six interfaces connected to the profile selecting section 110, namely: a communication circuit power management section 120; a communication circuit operation control section 130; a channel information I/F section 140; an application request I/F section 150; an action instructing section 160; and a device information I/F section 170. The profile controller 100 includes 3 input sections and 3 output sections.

Outputs signals from the channel information I/F section 140, the application request I/F section 150, and the device information I/F section 170 are supplied to the profile selecting section 110. The profile selecting section 110 supplies signals to the communication circuit power management section 120, the communication circuit operation control section 130, and the device information I/F section 170. FIG. 2 shows these signal flows.

As shown in FIG. 2, an electronic equipment (information processing device) 180 includes the profile controller 100, a communication device 200, and an electronic device 300. Note that, connecting wires 121, 131, 141, 151, 161, and 171 are identical with the wires shown in FIG. 1. Three signals supplied to the profile controller 100 indicate “request” from an application 310, “device information report” indicating device information 320 in the electronic device 300, and “channel information report” indicating channel information 220 in the communication device 200, respectively. Meanwhile, three signals outputted from the profile controller 100 indicate “application control” with respect to the application 310, “power management” with respect to the communication circuit 210, and “operation control” with respect to the communication circuit 210, respectively. Note that, the device information report includes device type information indicating the type of the electronic device 300.

Six connecting wires 121, 131, 141, 151, 161, and 171 for supplying three input signals and three output signals are connected to the profile selecting section 110, via six interfaces (120, 130, 140, 150, 160, and 170) shown in FIG. 1. The profile selecting section 110 is a core element of the profile controller 100. The profile selecting section 110 selects a suitable control profile, in accordance with three input signals (“request”, “device information report” and “channel information report”) supplied through the intermediary of the application request I/F section 150, the device information I/F section 170, and the channel information I/F section 140.

Also, as the signals “power management”, “operation control”, “application control”, the profile selecting section 110 outputs instructions stored in association with the selected control profile, through the intermediary of the communication circuit power management section 120, the communication circuit operation control section 130, and the action instructing section 160. These three output signals indicate the next power management state of the communication circuit 210, the operation state of the communication circuit 210, and the next state of the application 310, respectively. Following the instructions, the communication circuit 210 and the application 310 promptly changes the states.

The profile selecting section 110 which is a core element of the profile controller 100 includes the control profile table. The control profile table shows the relationships between (i) combinations of various conceivable states such as the characteristics of the device, the state of the application, the state of the device, and the state of the channel and (ii) combinations of control signals for indicating the power state of the communication circuit 210 required for operating the communication device 200, the operation state of the communication circuit 210, and the state of the application deeply related to the power saving of the electronic device 300. With reference to the control profile table, the profile selecting section 110 can find (read out) a control profile optimum for the combination of various conceivable states such as the characteristics of the device, the state of the application, the state of the device, and the state of the channel.

Therefore, it is preferable that a control profile is uniquely determined when the request from the application, the channel information, and the device information are provided. However, it is unnecessary that all of the combinations of these three items correspond to different control profiles. Also, even if a different type of the electronic device 300 corresponds to a different control profile, it is unnecessary that all types of the electronic devices 300 correspond to different control profiles. In order to allow the profile selecting section 1 10 to select a control profile corresponding to a different electronic device 300, the control profile table stores control profiles in association with device types of the electronic device 300.

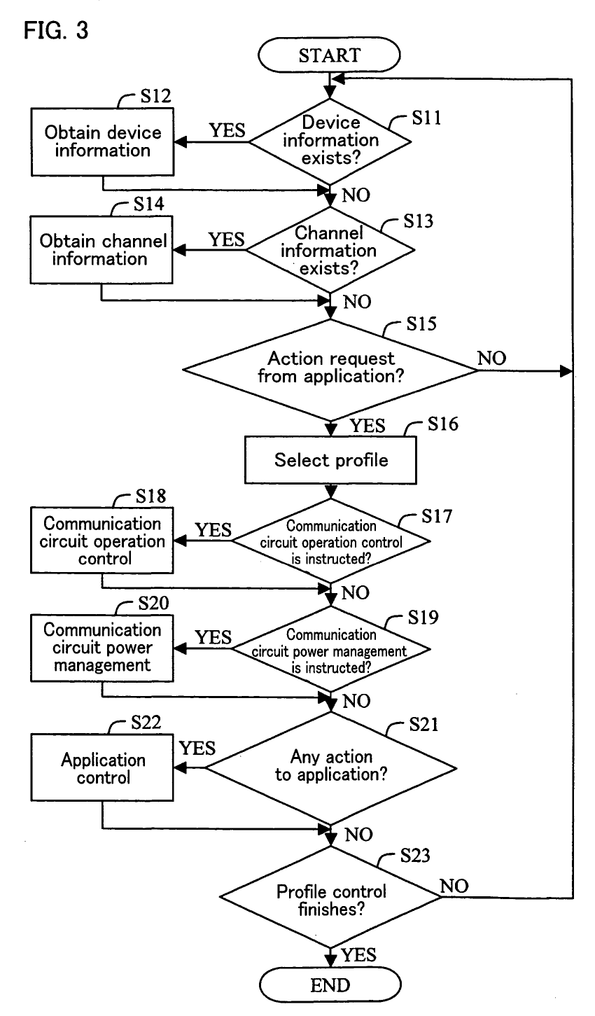

FIG. 3 is a flow chart showing an example of an operation flow of the profile controller 100. The operation flow will be discussed accordingly with reference to FIGS. 1 and 2. First, in Step S11, the device information I/F section 170 checks the presence of device information in the device information section 320. If the device information section 320 has the device information, the device information I/F section 170 obtains, in Step S12, the device information as “device information report”. On this occasion, the device information I/F section 170 also obtains the device type information added to the device information. In a similar manner, in Step S13, the channel information I/F section 140 checks the presence of channel information in the channel information section 220. If the channel information exists, the channel information I/F section 140 obtains, in Step S14, the channel information as “channel information report”.

In Step S15, if there is no action request from the application in the application request I/F section 150 (NO in Step S15), the process returns to Step S11 and the above-described steps are serially performed again from the observation of the device information.. Meanwhile, if there is an action request (YES in Step S15), the profile selecting section 110 selects, in Step S16, a control profile from the control profile table, with reference to the signals received by the application request I/F section 150, the channel information I/F section 140, and the device information I/F section 170.

Subsequently, the profile selecting section 110 serially performs the instructions stored in association with the selected control profile. In Step S17, it is confirmed whether or not the communication circuit operation control is instructed by the selected control profile. If the communication circuit control is instructed, the communication circuit operation control section 130 outputs, in Step S18, an “operation control” signal to the communication circuit 210. In a similar manner, in Step S19, it is confirmed whether or not the communication circuit power management is instructed by the selected control profile. If the communication circuit power management is instructed, the communication circuit power management section 120 outputs, in Step S20, a “power management” signal to the communication circuit 210. Furthermore, in Step S21, it is confirmed whether or not the control of the application is instructed by the selected control profile. If the control of the application is instructed, the action instructing section 160 outputs, in Step S22, an “application control” signal to the application 310.

In Step S23, if the control system of the electronic device 300 or a reset signal instructs the profile controller 100 to stop the operation, the profile controller 100 stops. On the other hand, if the stop of the operation is not instructed, the process returns to Step S11 and the above-described steps are serially performed again from the acquisition of the device information.

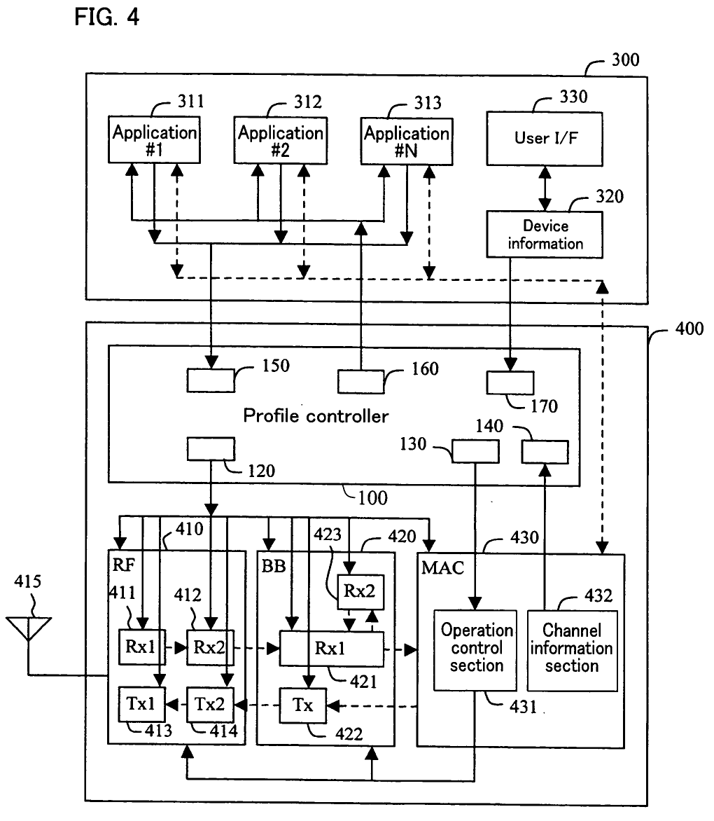

FIG. 4 illustrates a concrete example of how devices are connected around the profile controller 100 of the present embodiment. In the figure, six blocks provided in the profile controller 100 correspond to the interfaces 120 through 170 shown in FIG. 1. Dotted arrows indicate the flows of communication data, while full-line arrows indicate the flows of control data. For instance, in the electronic device 300, the device information section 320 collects (i) device operation mode information inputted by the user through the user I/F section 330, (ii) power source section information supplied from a power source section (not illustrated) provided in the electronic device 300, and (iii) device type information indicating the type of the electronic device 300, and supplies the “device information report” signal to the device information I/F section 170 in the profile controller 100.

A wireless communication equipment (communication equipment) 400 shown in FIG. 4 includes the profile controller 100, an RF section 410, a BB section 420, and a MAC section 430. The RF section 410, the BB section 420, and the MAC section 430 constitute a wireless control circuit, and this circuit corresponds to the communication device 200 shown in FIG. 2. In other words, the wireless communication equipment 400 includes the profile controller 100 and the communication device 200.

In the MAC section 430 which is in the wireless communication equipment 400 and is a part of the communication circuit, a channel information section 432 collects information regarding the channel, such as the quality of a received signal and the intensity of an electric field. The channel information section 432 then supplies a “channel information” signal to the channel information I/F section 140 in the profile controller 100. When applications 311-313 (e.g. applications #1, #2, and #N) installed in the electronic device 300 supply “request” signals to the application request I/F section 150, the profile controller 100 outputs three signals, with reference to the selected control profile.

If the selected control profile instructs an application to take a certain action, the action instructing section 160 outputs an “application control” signal to at least one of the applications (applications #1, #2, and #N) 311-313, which correspond to the instruction. The application received the “application control” signal changes the operation state in accordance with the signal.

The communication circuit operation control section 130 outputs an “operation control” signal to the operation control section 431 in the MAC section 430. The operation control section 431 controls the operation of the communication circuit, in a predetermined manner, so as to set the circuit to basic operation states such as sending, receiving, and waiting for the reception. Also, the operation control section 431 controls and causes the communication circuit to, for instance, repeat a pattern of changes of the basic operation state for a certain period of time. Under the control by the operation control section 431, the BB section 420 performs modulating and demodulating operations, while the RF section 410 performs wireless sending and receiving operations.

When the communication circuit power management section 120 outputs the “power management” signal in accordance with the control profile, (i) the power sources of the RF sections 410, the BB section 420, and the MAC section 430 constituting the wireless communication circuit, (ii) the operating power sources of circuit blocks (Rx1, Rx2, Tx1, and Tx2) 411-414 in the RF section 410 and circuit blocks (Rx1, Rx2, and Tx) 421-423 in the BB section 420 are individually controlled in accordance with the control profile, so that the respective circuits are turned ON/OFF. Suitably selecting the circuit block makes it possible to reduce unnecessary power consumption, so that the power saving is realized.

In FIG. 4, the profile controller 100 is provided in the wireless communication equipment 400. The structure shown in the figure makes it possible to reduce the power consumption on the occasion of adopting the wireless communication equipment 400, regardless of the type of the electronic device 300. The more the number of the types of the electronic device 300 which are supported by the profile controller 100, the more the convenience (versatility) increases and the manufacturing costs decrease thanks to volume efficiency. In other words, a communication device which can operate with low power consumption, can be manufactured at low costs, and have versatility is provided. As a matter of course, the effects above can be realized with structures other than the above-described structure shown in FIG. 4.

The profile controller 100 may be realized as a piece of software or a combination of hardware and software. When being realized as a piece of software, the profile controller 100 may be provided in the electronic device 300 rather than in the wireless communication equipment 400. When the profile controller 100 which is a piece of software is provided in the electronic device 300, the “device type” item in the control profile table is restricted to the electronic device 300 in which the profile controller 100 is provided. With this, it is possible to save the capacity of a memory such as ROM which stores the control profile and the like.

If reasons in respect of design, manufacturing and the like require, the profile controller 100 may be provided astride the wireless communication equipment 400 and the electronic device 300, rather than in either the wireless communication equipment 400 or the electronic device 300. For instance, the following sharing of functions may be done: while a hardware part of the profile controller 100 is provided in the wireless communication equipment 400, a software part of the profile controller 100 is provided in the electronic device 300. In such a case, it is preferable that the operation with low power consumption is effectively realized as the wireless communication equipment 400 and the electronic device 300 work together as if they are one unit.

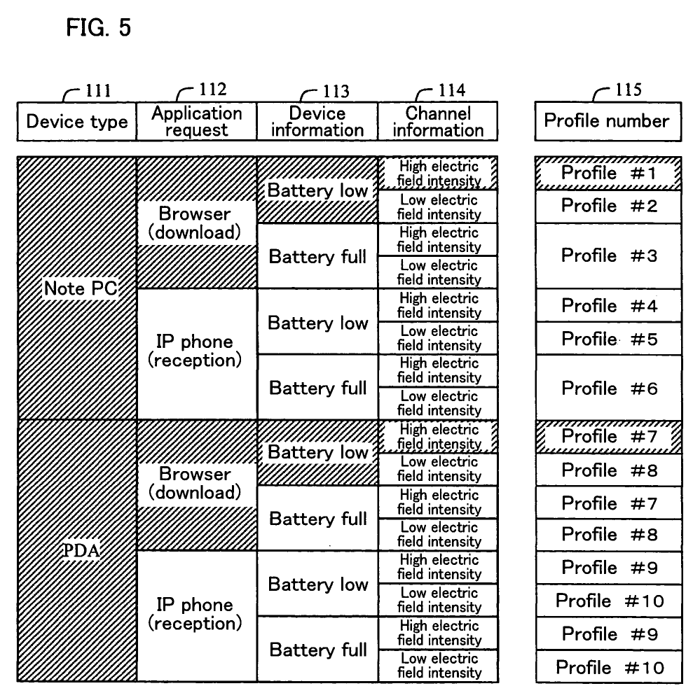

FIG. 5 shows an example of the control profile table of the present embodiment. As in the figure, the control profile table of the present embodiment includes the following four items: device type (device type information) 111 which is an item indicating which type of device the electronic device 300 is; and three inputs to the profile controller 100, which are request 112, device information 113, and channel information 114. In the example shown in FIG. 5, two items (note PC and PDA) are wrote in the device type 111. Downloading using a browser and receiving a phone call using an IP phone fill the application request 112, while the device information 113 shows a case of low battery power (battery low) and a case of full battery power (battery full). The channel information 114 shows a case of high electric field intensity and a case of low electric field intensity. In the example in FIG. 5, the total number of combinations is 16, and a profile number 115 is assigned to each of the combinations. As in the figure, a control profile is uniquely determined in accordance with the combination of the items (elements). However, the figure also shows that not all of the combinations correspond to different control profiles. In this example, only 10 types of control profiles are provided for 16 combinations. Note that, the device information (remaining battery resource) and the channel information (electric field intensity or the frequency of error) may be expressed by numerical ranges rather than binary numbers based on a predetermined threshold, as shown in FIG. 5. With this, the control can be performed in a subtler manner.

The elements in the items of an actual control profile table are not limited to those in FIG. 5. For instance, the device type 111 includes, apart from note PC and PDA, electronic devices 300 related to communication functions, such as television, cordless phone, and mobile phone. The application request 112 includes, for instance, data transmission and data receiving process requests such as browser, e-mail, IP phone, and streaming. The device information 113 includes elements such as whether or not battery-powered. (AC battery), remaining battery resource, and whether or not power saving operation in response to the instruction from the user is carried out. The channel information 114 includes elements such as the quality of communication data and delay spread, apart from the existence of the carrier and the electric field intensity. Since most of the parameters which are taken into consideration on the occasion of performing the operation in a power saving mode fall into these items, the more the number of items increases, the more the reduction of the power consumption is effectively carried out.

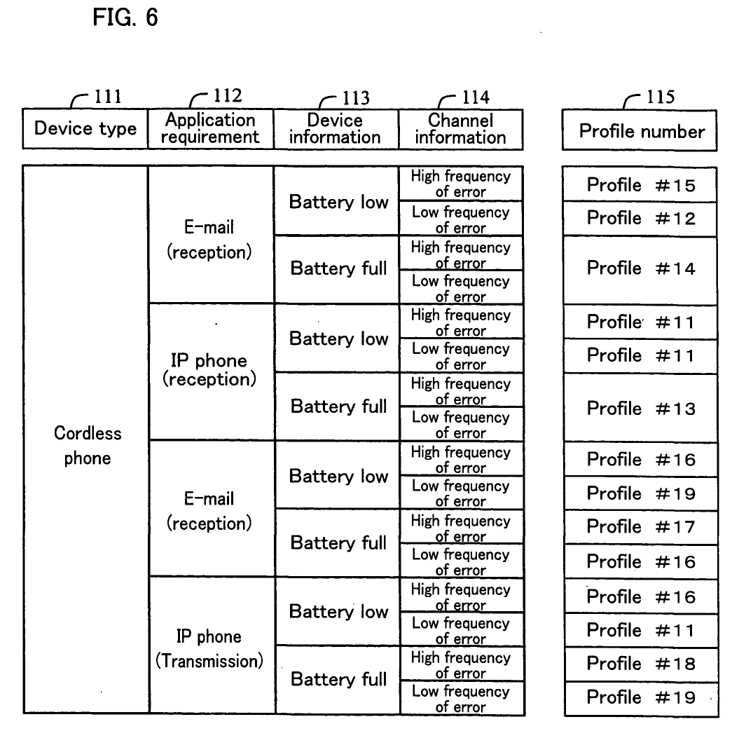

FIG. 6 shows another example of the control profile table. In this example, the device type 111 is cordless phone, and the application requests 112 includes four types of elements: e-mail (sending and receiving) and IP phone (sending and receiving). The device information 113 includes two types of elements: battery low and battery full, and the channel information 114 includes two types of elements: high frequency of error and low frequency of error. The profile number includes nine types of elements from 11 to 19. The total number of combinations is 16, and some of them share an identical profile number. For instance, a situation where the battery power is low and the frequency of error is high on the occasion of sending an e-mail is substantially identical with a situation where the battery power is low and the frequency of error is high on the occasion of making an IP phone call. For this reason, an identical profile number 16 is assigned to both of these situations.

As described above, the control profile table shows how the real-time information regarding the electronic device 300, the real-time information regarding the communication device 200, and the control profile are related to each other. Referring to this control profile table, the profile controller 100 mediates the exchanges between the electronic device 300 and the communication device 200, so as to control the power consumption to a downward tendency.

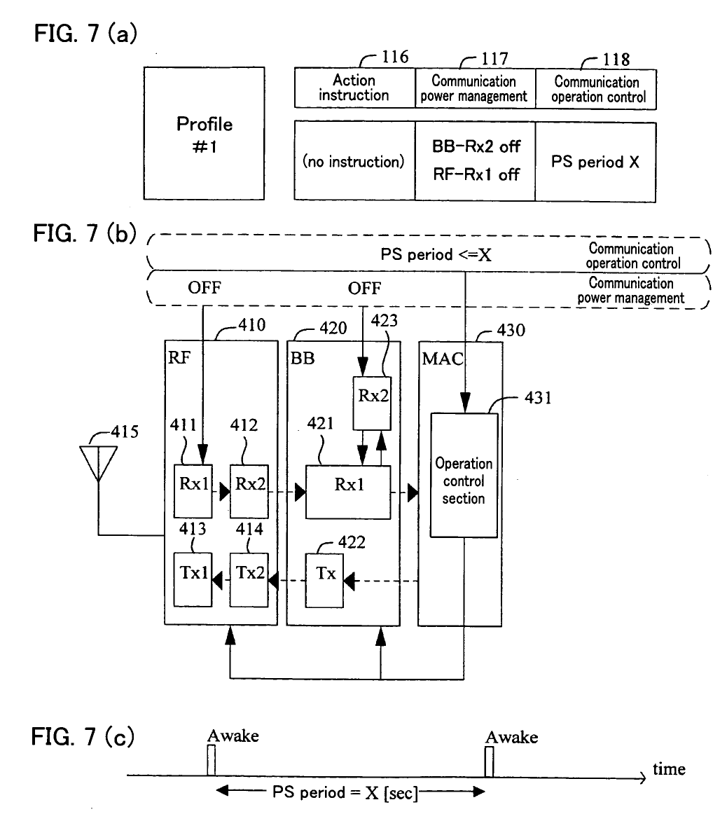

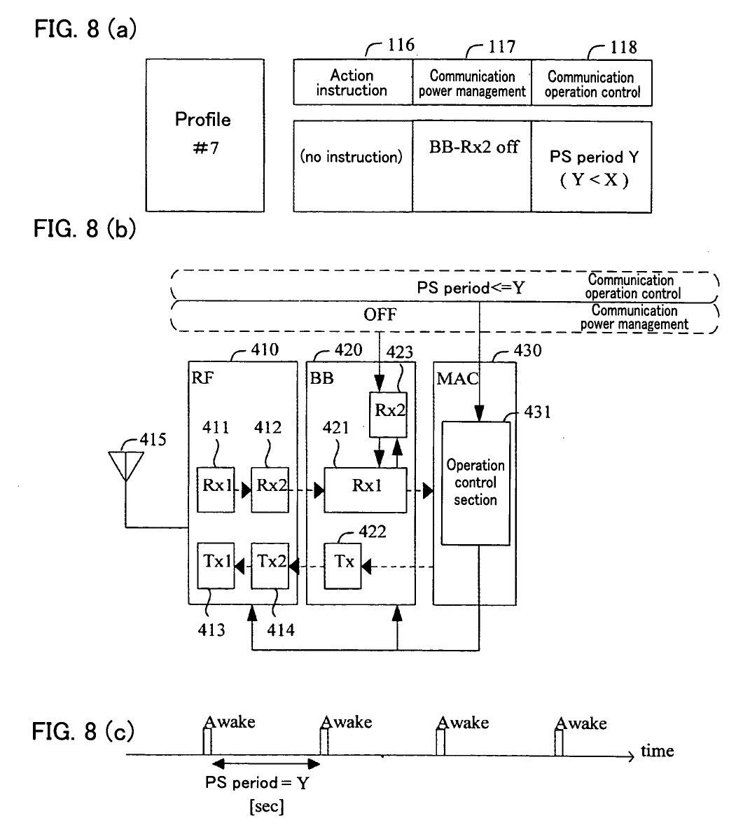

Now, with reference to FIGS. 7(a)-7(c) and 8(a)-8(c), an example of an actual operation based upon the control profiles shown in FIGS. 5 and 6 will be illustrated. FIGS. 7(a) and 8(a) show examples of instructions based upon the control profiles 1 and 7. FIGS. 7(b) and 8(b) schematically show examples of the control of the communication circuit by the control profiles shown in FIGS. 5 and 6. FIGS. 7(c) and 8(c) schematically show the intervals of intermittent receptions on the occasion of a power saving (PS) mode. Note that, members of the communication circuits shown in FIGS. 7(b) and 8(b) are given the same numbers as those of the communication circuit in FIG. 4.

FIG. 7(a) shows a control profile in which the items in FIG. 5 are determined as follows: the device type 111 is note PC; the application request 112 indicates the downloading of a browser; the device information 113 indicates low battery power; and the channel information 114 indicates high electric field intensity. From FIG. 5, the profile selecting section 110 selects the profile #1 as a control profile. FIG. 7(a) shows three outputs in the case of selecting the profile #1. According to the figure, the profile #1 instructs as follows: action instruction 116, which is equivalent to the “application control” signal, indicates “no instruction”; communication power management 117, which is equivalent to the “power management” signal, is “BB-Rx2off” and “RF-Rx1off”; and communication operation control 118, which is equivalent to the “operation control” signal, is “PS period X”. Since the action instruction 116 is “no instruction”, the application is not controlled by the profile controller 100. By the remaining two output signals, only the communication circuit is controlled.

FIG. 7(b) shows how the communication circuit is controlled. Since the communication power management 117 indicates “BB-Rx2off”, the communication circuit power management section 120 outputs a control signal in such a manner as to cause an Rx2 section 423 in the BB section 420 shown in FIG. 4 to turn off. As a result, the power supply to the Rx2 section 423 stops. Similarly, since the communication power management 117 also indicates “RF-Rx1off”, the communication circuit power management section 120 also outputs a control signal in such a manner as to cause an Rx1 section 411 in the RF section 410 to turn off. As a result, the power supply to the Rx1 section 411 stops. On this account, the received signal passes through the Rx1 section 411 in the RF section 410, and is demodulated without going through the Rx2 section 423 in the BB section 420. Note that, before performing these controls, the received signal is modulated by passing through an antenna 415, the Rx1 section 411 in the RF section 410, the Rx2 section 412 in the RF section 410, the RX1 section 421 in the BB section 420, and the Rx2 section 423 in the BB section 420. In this case, although the receiving characteristics are not good, the receiving quality is still good enough for the demodulation, so that the data is successfully received. In addition, two of the receiving circuit blocks have shifted in a power-off state, and hence the power consumption is reduced comparing to the normal operation.

Since the communication operation control 118 indicates “PS period X”, the operation control section 431 in the MAC section 430 is instructed to arrange the receiving interval on the occasion of performing a PS operation to be X seconds. Following this instruction, the operation control section 431 after the communication of the present time operates in a power saving mode (PSM), and a time counter starts in order to resume the communication after X seconds. FIG. 7(c) shows this process. In the figure, the time termed Awake is a period during which the communication is carried out, while, in a PS period, neither sending nor receiving is performed.

Note that, the PSM is defined as an option in IEEE 802.11 which is a U.S. wireless LAN standard. In this mode, a device of the receiving end receives a packet termed beacon, at certain intervals. Upon receiving the beacon, the device of the receiving end starts the communication if there is data directed to the device, while, if there is no data directed to the device, the device returns to the non-communication state and waits the next timing of reception. The period in which the device is not performing the receiving operation can be arbitrarily arranged. FIG. 7 shows this period as the PS period.

In this manner, with reference to a control profile uniquely selected in accordance with three inputs to the profile controller 100, the profile controller 100 determines three outputs. In the communication device 200, the communication circuit is controlled in a subtle manner by these three outputs, so that the operation in a low power consumption mode is easily realized.

In FIGS. 7(a)-7(c), the device type 111 is note PC. Now, with reference to FIGS. 8(a)-8(c), a case where the communication device 200 is mounted on a PDA will be discussed.

FIGS. 8(a)-8(c) show an example of an operation in which the items in FIG. 5 are determined as follows: the device type 111 is PDA, the application request 112 indicates the downloading of a browser, the device information 113 indicates low power battery, and the channel information 114 indicates high electric field intensity. A major difference between the present example and the previous example shown in FIG. 7(a)-7(c) only lies in the device type 111, and the other three items (112-114) are identical. As shown in FIG. 5, the profile selecting section 110 in this case selects the profile #7 as a control profile.

As shown in FIG. 8(a), three outputs according to the profile #7 are as follows: the action instruction 116 is “no instruction”, the communication power management 117 is “BB-Rx2off”, and the communication operation control 118 is “PS period Y”. As frequently carried along, the reception cannot be easily stabilized in PDAs as compared to note PCs. For this reason, the “RF-Rx1off” in FIG. 7(a) is not included in the present case. Furthermore, since the user is likely to perform the communication while moving, the PS period in the communication operation control is defined so as not to miss a device AP. More specifically, the PS period in the present case is Y seconds which is shorter than X seconds. In this manner, when the device type 111 is different, a different profile is adopted in many cases. When a different control profile is adopted, the communication circuit is controlled in a different way.

FIG. 8(b) shows how the communication circuit is controlled by three outputs shown in FIG. 8(a). Since the communication power management 117 is “BB-Rx2off”, the communication circuit power management section 120 outputs a control signal in such a manner as to turn off the Rx2 section 423 in the BB section 420. As a result, the power supply to the Rx2 section 423 stops. Also, since the communication operation control 118 is “PS period Y”, the operation control section 431 in the MAC section 430 is instructed to arrange the receiving interval on the occasion of performing the PS operation to be Y seconds. With this instruction, the operation control section 431 controls and causes the RF section 410 and the BB section 420 to repeat the receiving operation at intervals of Y seconds, as shown in FIG. 8(c).

With reference to FIG. 5, a case where a profile number different from the above is selected will be discussed. For instance, when the device type 111 is note PC, the application request 112 is IP phone, the device information 113 is low battery power, and the channel information 114 is low electric field intensity, the profile selecting section 110 selects the profile #5 as a control profile.

Since an IP phone has to perform sending and receiving at predetermined intervals, the communication power management 117 cannot give an instruction to turn off the Rc and Tx of the BB and the Rx and Tx of the RF. For this reason, the communication power sources are all in the ON state during a PS period Z (Z<X because a time for one session of data sending and receiving is shorter than the downloading of a browser). Furthermore, when the electric field intensity is low, the communication device 200 has to increase the sending power to allow the receiving end to receive the call, so that the power consumption is unavoidably increased.

However, on the occasion of low battery power, the increase in the power supply to the communication device 200 causes the operation of the electronic device 300 to be difficult to be performed, so that the electronic application (IP phone) cannot be used for a long period of time. For this reason, the profile controller 100 gives, to the application, an action instructing “the application of the IP phone is stopped after a predetermined period of time”. With this, the IP phone application stops after a predetermined period of time, so that the power consumption of the electronic device 300 is reduced.

As described above, when different electronic devices 300 use an identical communication device 200, the communication device 200 is connected to each electronic device 300 via the profile controller 100, so that each electronic device 300 is controlled in an optimum manner. For this reason, on account of the profile controller 100, it is possible to provide a communication device 200 which can operate in a low power consumption mode in an appropriate operation range and has a high degree of versatility.

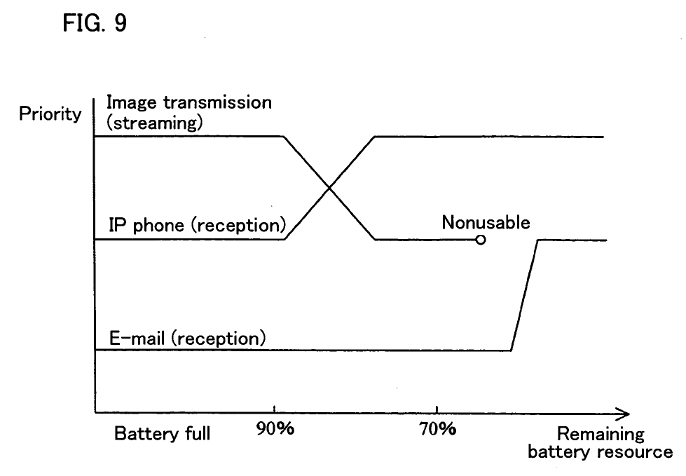

FIG. 9 shows an example of relationships between priorities (weighting coefficients) referred to on the occasion of selecting the control profile and the remaining battery resource.

Assume that the following applications simultaneously run: image transmission (streaming); IP phone; and mailer. In such a case, the communication has to be performed most frequently in the image transmission (streaming) which requires to send or receive images without interruption the second most frequent communication is performed by the IP phone which regularly checks the existence of an incoming call in order to react to the call even when telephone communication is not performed. The least frequent communication is performed by the mailer which carries out the communication only when the need arises. The power consumption by the application decreases in proportion to the communication frequency, i.e. the power consumption decreases in the following order: the image transmission (streaming) comes first, the IP phone comes second, and the mailer comes third.

For instance, as shown in FIG. 9, when the battery is fully charged or an AC power source is available, a high priority is given to the application which frequently performs communication such as the image transmission (streaming), i.e. the application consuming large amounts of power. In the meantime, an intermediate priority is given to the reception of an IP phone call, and a low priority is given to the reception of an e-mail which performs communication less often and hence consumes fewer amounts of power. In this manner, when the battery is fully charged or an AC power source is available, the control is carried out so as to be optimum for the most prioritized application among executable applications. When the remaining battery resource is reduced to about 90%, the priority of the application which frequently performs communication, i.e. the application consuming large amounts of power is gradually lowered, while a higher priority is given to the reception of an IP phone call. When the remaining battery resource is reduced to not more than 70%, the use of the application which frequently performs communication, i.e. the use of the application consuming large amounts of power is forbidden in order to restrain the draining of the battery, while a higher priority is given to the reception of an e-mail, with the priority of the reception of an IP phone call being kept to be high. Bearing this technical idea in mind, a control profile appropriate to each application is selected, so that the operation in a low power consumption mode, which is the objective of the present invention, is efficiently realized. Note that, the following arrangement makes it possible to perform the control in a more subtle manner: Weighting coefficients are allocated to the respective elements such as the device type, the application request, the device information, and the channel information shown in FIGS. 5 and 6, and these weighting coefficients are varied in accordance with the change of, for instance, the combination of the elements.

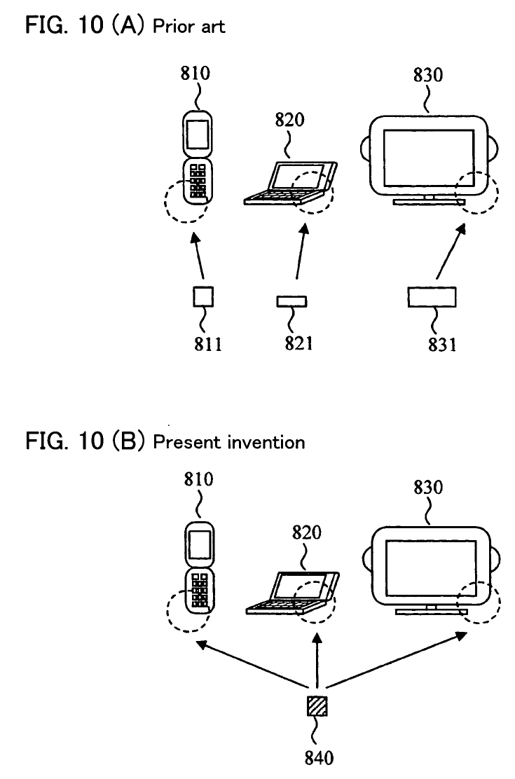

FIGS. 10(A) and 10(B) illustrates that a high degree of versatility is obtained using a communication equipment including the profile controller 100 of the present embodiment. FIG. 10(A) shows a conventional communication device, while FIG. 10(B) shows a communication equipment including the profile controller 100 of the present embodiment. As shown in FIG. 10(A), to perform an efficient operation of a conventional communication device in a low power consumption mode, a mobile phone 810 requires a communication device 811 designed to be optimum for the mobile phone 810, a PDA 820 requires a communication device 821 designed to be optimum for the PDA 820, and a television 830 requires a communication device 831 which is designed to be optimum for the television 830.

On the other hand, thanks to the profile controller 100, as shown in FIG. 10(B), a communication equipment 840 adopting the profile controller 100 of the present embodiment allows all of the mobile phone 810, PDA 820, and television 830 to perform an optimum operation in a low power consumption mode. Such a high degree of versatility makes it possible to manufacture communication equipments irrespective of the production volume of electronic devices to which the communication equipments are connected. In other words, communication equipments each including the profile controller 100 can be manufactured at low cost thanks to volume efficiency. Note that, although the descriptions above premises that the profile controller 100 is mounted on a communication equipment, the profile controller 100 may be mounted on each electronic device. Also in this arrangement, the reduction of the manufacturing costs of the communication device thanks to volume efficiency is realized.

The profile controller 100 requires at least three inputs and three outputs shown in FIG. 1. In addition to them, a request from the user may be added as an input, in order to allow the user to intentionally limit the operation. In the example shown in FIG. 4, this request is a part of the device information. When the request from the user is added to the profile controller, it is necessary to newly add an item termed “request from the user” to the control profile table which is referred to by the profile selecting section. It is, however, clear that this arrangement does not change the structure, objective, and effects of the present invention at all.

The profile controller 100 may obtain, from the communication device 200, operation state information indicating the operation state of the communication device 200. This operation state information indicating the operation state of the communication device 200 is, for instance, information indicating electric power supplied to the communication device 200. In this case, an item termed “operation state of the communication device 200” is newly added to the control profile table, so that the profile selecting section 110 selects a control profile, with reference to the obtained operation state information. In this manner, the profile controller 100 can control the communication device 200 and the electronic device 300, in accordance with the operation state of the communication device 200.

As described above, the control device (profile controller) of the present invention selects a control profile optimum at that time, with reference to three inputs (request from the application, the device information, and the channel information (e.g. BER and PER)). In accordance with the selected control profile, the control device then outputs three signals (the application control, the communication circuit power management, and the communication circuit operation control), so as to control the communication device and the application. As a result, the communication device can be operated at a low power consumption mode, and/or the whole device including the communication device can be operated at a low power consumption mode.

A profile controller at least having three inputs (the request from the application, the device information, and the channel information) and three outputs (the application control, the communication circuit power management, and the communication circuit operation control) is placed between a communication device and an electronic device main body to which the communication device is connected. With this, a multipurpose communication device which can be manufactured at low cost thanks to volume efficiency can perform the operation at a low power consumption mode in compliance with the application, device state, channel state and so on, irrespective of the type of electronic device which uses the communication device.

### Embodiment 2

Now, the following gives a specific explanation over an embodiment in which the power saving of a communication device is efficiently performed on the occasion of simultaneously running a plurality of applications.

In the present specification, operational characteristics of an application is operational characteristics (time, amounts of data, and so on) required to a wireless transmission circuit when the application uses the wireless transmission circuit (communication device). Influences on the application indicates the influences on a processing result expected to each application.

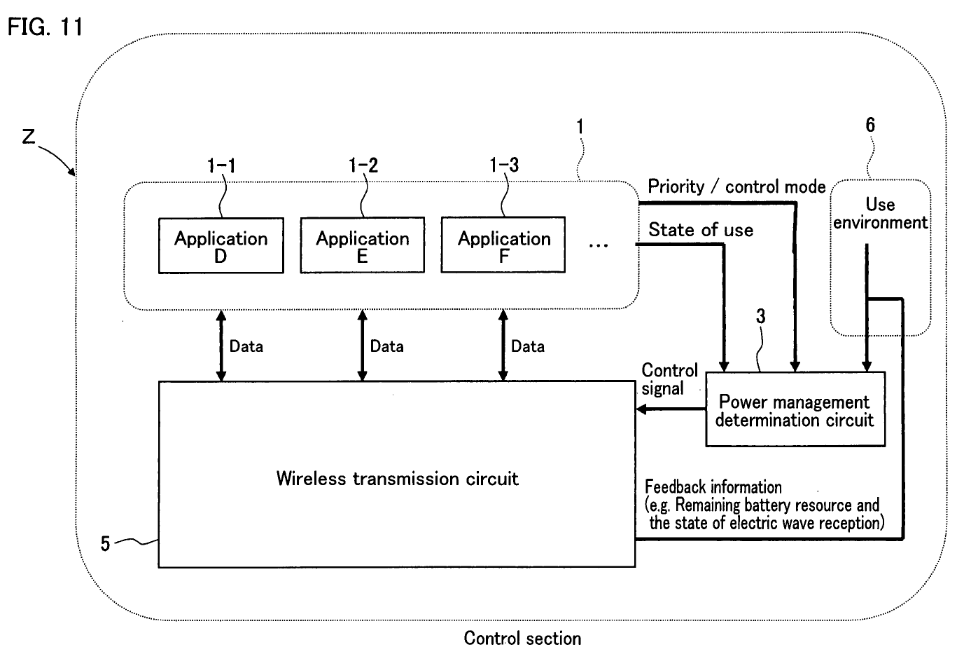

Before illustrating a device management system of the present embodiment of the present invention, the principle of the present invention is briefly described. FIG. 11 outlines the power saving process in a wireless transmission circuit (communication device) 5 of the present invention. As shown in the figure, a device (information processing device) Z of the present device management system includes a power management determination circuit (control device) 3, a wireless transmission circuit 5, and an electronic device for executing three applications (applications D, E, and F). Note that, although the electronic device is not shown in FIG. 11, the electronic device is identical with the electronic device 300 storing the application as shown in FIG. 2.

To the power management determination circuit 3, state of each of the applications, use environment of the device Z, control mode of electric power management required to the wireless transmission circuit 5 by an application, and priorities are inputted. Examples of the applications include an application D(1-1), an application E(1-2), and an application F(1-3). The state of the application indicates, for instance, whether or not the application is in use. The use environment of the device Z indicates, for instance, the size of an area in which the device Z is used, the state of electric wave reception, and remaining battery resource. The control mode may be determined by the user or may be determined in advance. In a similar manner, the priorities may be determined by the user or may be determined in advance. That is to say, the control mode and the priorities may be arranged such that: both of them are determined by the user; both of them are determined in advance; or one of them is determined by the user, while the other one of them is determined in advance.

With reference to the state of each application, the use environment of the device, the control mode, and the priorities being inputted, the power management determination circuit 3 determines an optimum control method, and supplies, to the wireless transmission circuit 5, a control signal corresponding to the control method being determined. The wireless transmission circuit 5 operates in accordance with the optimum control method determined by the power management determination circuit 3. The power management determination circuit 3 determines the optimum control method in consideration of the incomplete reception, response, delay, and quality, and controls the wireless transmission circuit 5 in accordance with this control method. Feedback information (e.g. remaining battery resource and the state of electric wave reception) from the wireless transmission circuit 5 is fed back to the power management determination circuit 3, as use environment information. In this manner, the power management determination circuit 3 updates the optimum control method, so that the wireless transmission circuit 5 is properly controlled.

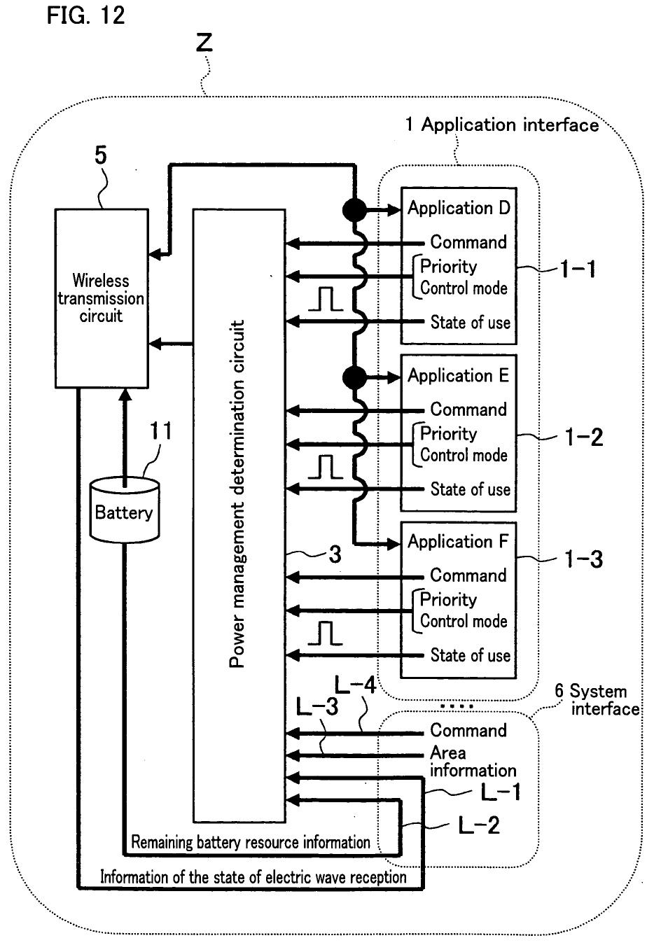

FIG. 12 shows how the device (information processing device) Z of the device management system in accordance with an embodiment of the present invention is structured.

As in the figure, the device Z includes, for instance, a plurality of applications D, E, and F and an application interface 1 which connects an electronic device on which the applications run with another circuit. In addition to them, the device Z includes the power management determination circuit 3, the wireless transmission circuit 5, and a system interface 6. A battery 11 is additionally included for supplying electric power to the wireless transmission circuit 5.

The application interface 1 includes, for instance, an interface 1-1 of the application D, an interface 1-2 of the application E, and an interface 1-3 of the application F. Each of these interfaces 1-1 through 1-3 outputs priority, control mode, state of use, and command, which are described below, to the power management determination circuit 3. The system interface 6 outputs remaining batter power information L-2, information of the state of electric wave reception (channel information) L-1, area information L-3, and command L-4 to the power management determination circuit 3.

Upon receiving these input signals, the power management circuit 3 generates a detailed parameter determination signal 33 (not illustrated in FIG. 12), and outputs this signal to the wireless transmission circuit 5. This detailed parameter determination signal 33 is used for determining a detailed parameter for controlling the wireless transmission circuit 5. A detailed description of this signal will be given later. The battery 11 supplies electric power to the wireless transmission circuit 5, and outputs the remaining battery resource information L-2 to the power management determination circuit 3 via the system interface 6.

Now, input signals to the power management determination circuit 3 are described. In regard to each application, priority, control mode, state of use, and command are supplied from the application interface 1 to the power management determination circuit 3. In regard to the whole system, the area information L-3, the remaining battery resource information L-2 which is feedback information, the information of the state of electric wave reception L-1, and the command L-4 are supplied from the system interface 6 to the power management determination circuit 3.

The above-described input signals are further discussed. The input signals regarding each application includes, as described above, the priority, the control mode, the state of use, and the command. The priority indicates, among a plurality of applications, which application is preferentially subjected to the power saving process. In the present embodiment, a smaller positive integer indicates a higher priority, and different applications do not have an identical priority. The priority may be appropriately varied from a default value, or the default value may be updated in accordance with the past state of use. The control mode indicates a method for controlling electric power regarding the application, and is determined by, for instance, the user. Alternatively, a default method may be assigned to each application.

As shown in FIG. 12, in the device Z of the device management system of the present embodiment, a command of an application or a command of a system to which the system interface 6 is connected may be used for controlling the electric power. In other words, the application interface 1 can output a command to each of the applications. Moreover, the system interface 6 can output the command L-4. This command can be inputted by the user, so that the electric power management in regard to the command can be performed in an interruptive manner, in accordance with the input from the user.

Examples of the command include power management command, transmission output level control command, and reception sensitivity level control command. For instance, the command regarding the application interface 1 is determined in accordance with the priority and the state of use, as in the case of determining an electric power management method described later. In the meanwhile, a higher priority is given the command regarding the system interface 6 compared to the command regarding the application interface 1, and the command regarding the system interface 6 is supplied to the wireless transmission circuit 5 via the power management determination circuit 3.

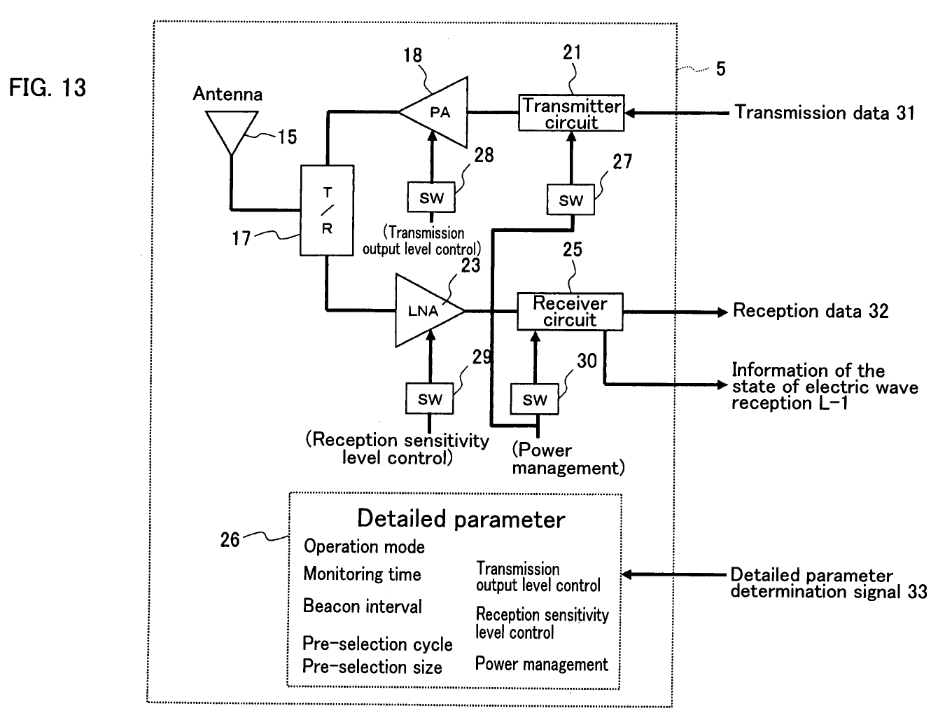

FIG. 13 is a functional block diagram showing an example of the wireless transmission circuit 5 in FIG. 12. As in this figure, the wireless transmission circuit 5 of the present embodiment includes an antenna 15, a T/R (transmission/reception switch) 17, a power amplifier PA18, a transmitter circuit 21, a low-noise amplifier LNA23, a receiver circuit 25, power management switches 27-30, and a member storing a detailed parameter 26. The detailed parameter 26 includes operation mode, monitoring time, beacon receiving interval, pre-selection cycle, pre-selection size, power management, transmission output level control, and reception sensitivity level control.

As described below, the transmission output level control is to restrain the transmission output power and carries out the power saving, by managing the electric power supplied to the power amplifier PA18 using the power management switch 28. The reception sensitivity level control is to restrain the reception sensitivity level so as to perform the power saving, by controlling the power supply to the low-noise amplifier LNA23 by the power management switch 29. The power management is to carry out the power saving by managing the electric powers supplied to the transmitter circuit 21 and the receiver circuit 25, using the power management switch 27 and the power management switch 30.

The power amplifier PA18 amplifies a signal to be transmitted, the signal being supplied from the transmitter circuit 21, so as to output the signal to the T/R 17 of the following stage. For instance, when the distance between a master terminal and a slave terminal is short, it is unnecessary to increase the transmission output power. For this reason, the power management switch 28 stops the power supply to the power amplifier PA18. With this, the power saving is realized. Meanwhile, when the distance between a master terminal and a slave terminal is long, the power management switch 28 supplies the electric power to the power amplifier PA18, causing an amplified signal to be transmitted.

The low-noise amplifier LNA23 amplifies a signal received by the antenna 15. For instance, when the distance between a master terminal and a slave terminal is short, the power management switch 29 stops the power supply to the low-noise amplifier LNA23, because the level of the received signal is high enough, so that the amplification of this signal is unnecessary. With this, the power saving is realized. Meanwhile, when the distance between a master terminal and a slave terminal is long, the power management switch 29 supplies electric power to the low-noise amplifier LNA23, thereby amplifying the received signal.

The operation mode indicates a below-mentioned electric power management method, and the monitoring time, the beacon receiving interval, the pre-selection cycle, and the pre-selection size are used in each operation mode. Transmission data 31 supplied to the transmitter circuit 21 is supplied from the applications D, E, and F. Reception data 32 outputted from the receiver circuit 25 is supplied to the applications D, E, and F. The information of the state of electric wave reception L-1 indicates the state of electric wave reception of the wireless transmission circuit 5, which is figured out based on the information of the receiver circuit 25. The detailed parameter determination signal 33 determines each value of the detailed parameter 26.

With reference to this FIG. 13, the following will describe how wireless data transmission by the wireless transmission circuit 5 is carried out. The transmission data 31 of each application is, as wireless data, outputted to a wireless network, using the transmitter circuit 21, the power amplifier PA18, the transmission/reception switch 17, and the antenna 15. The reception data 32 of each application is fetched from the wireless network via the antenna 15, the transmission/reception switch 17, the low-noise amplifier LNA23, and the receiver circuit 30. Note that, the present embodiment is an example of wireless data transmission in which the transmission and the reception are switched over and processed.

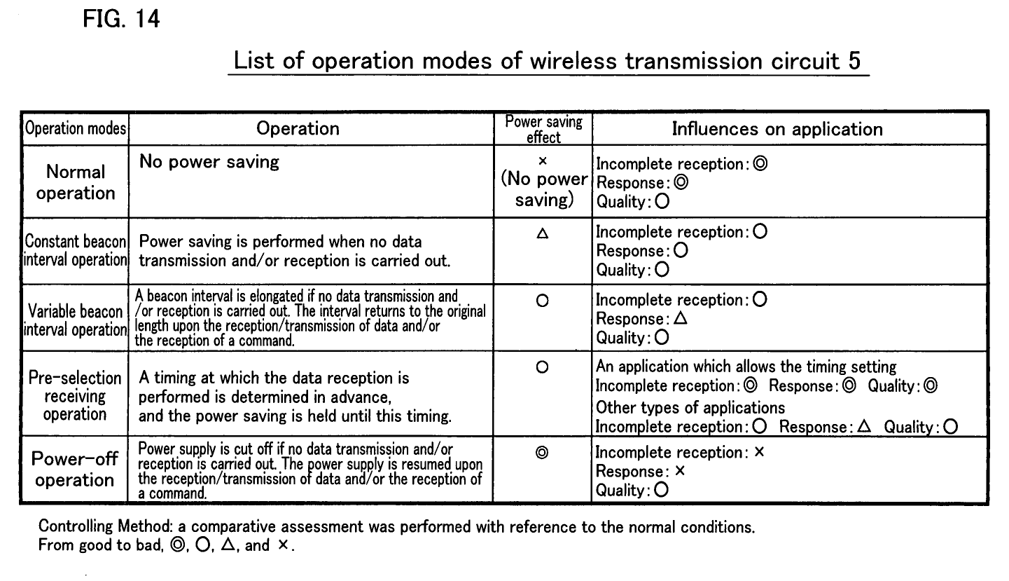

FIG. 14 shows a list of items regarding the power saving of the wireless transmission circuit 5, such as operation modes, power saving effect, and influence on the application. As in this figure, there are five types of operation modes: normal operation, constant beacon interval operation, variable beacon interval operation, pre-selection receiving operation, and power-off operation. These operation modes are different from each other in terms of the operation of the transfer circuit 5, the power saving effect, and the influences on the application.

In the normal operation, the power saving is not performed so that no power saving effect is obtained. With regard to the influence on the application, incomplete reception rarely occurs, and the response is quick. The quality (throughput) is good.

In the constant beacon interval operation, a beacon signal BS is received at constant time intervals, and the power saving is performed when no data transmission and/or reception is carried out. The power saving effect in this case is better than the effect in the normal operation. The incomplete reception, the response, and the quality are all on standard levels.

In the variable beacon interval operation, the interval between the receptions of the beacon signal BS is elongated if the data reception and/or transmission is not carried out for a predetermined period of time. When the data reception and/or transmission is carried out or a command is received, the interval returns to the original length. The power saving effect in this case is better than the effect in the constant beacon interval operation. The incomplete reception and the quality are on standard levels, but the response speed is slightly slowed down because it takes time to return the interval to the original length.

The pre-selection receiving operation is to set, in advance, a timing at which data is received. The power saving state is held until the timing of the reception. The power saving effect is also good in this case. In an application which allows the timing setting, the incomplete reception rarely occurs, the response is quick, and the quality is good. However, in an application which does not allow the timing setting, the influence on this application is similar to the influence in the case of the constant beacon interval operation.

In the power-off operation, the wireless transmission circuit 5 is switched to the power saving state if no data transmission and/or reception is carried out for a predetermined period of time. The wireless transmission circuit 5 returns to the normal state upon the data transmission and/or the reception of the power management command. In this case, since the wireless transmission circuit 5 is on the power saving state, the power saving effect is considerable. However, the incomplete reception may occur and the response speed is slowed down. The quality is on a standard level. In this manner, each operation mode has advantages and defects.

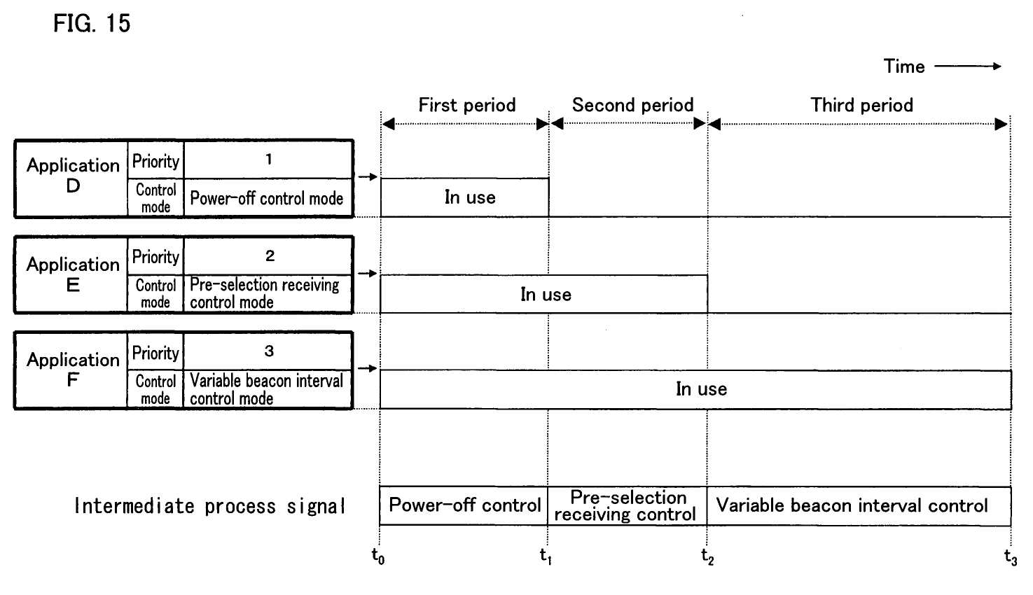

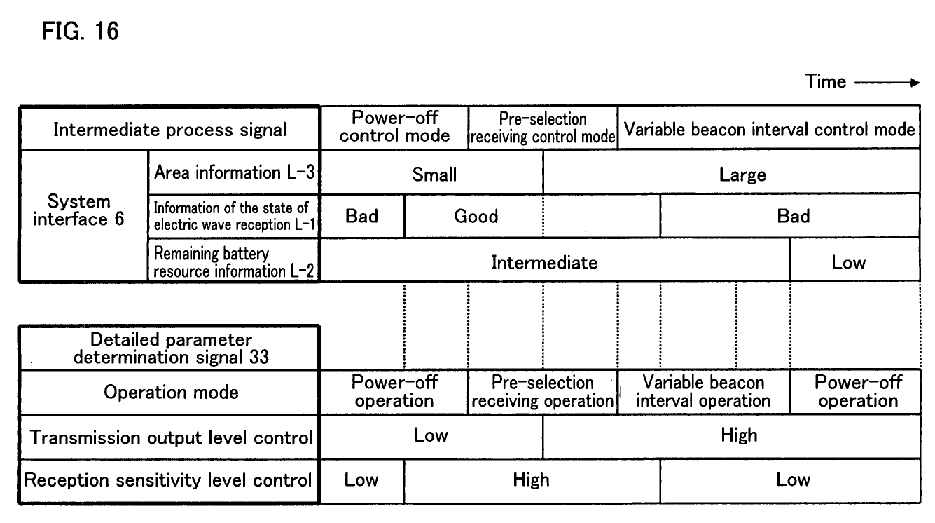

Now, with reference to FIGS. 15 and 16, the following will discuss a determination procedure to determine, in the power management determination circuit 3, the detailed parameter determination signal 33 supplied to the wireless transmission circuit 5 and an intermediate process signal which is preliminary process information for figuring out the detailed parameter determination signal 33.

FIG. 15 illustrates a procedure to determine the intermediate process signal which is preliminary process information for figuring out the detailed parameter determination signal 33 of the wireless transmission circuit 5. The state of use of the application is detected with reference to the timing signal. The application is in use when the timing signal is detected, while the application is not in use when no timing signal is detected. The detection of the timing may be performed in the following manner: a timing signal indicating the in-use state is outputted from the application, or a timing signal is fetched from information managed by the device. The intermediate process signal is determined with reference to the timing signal indicating the in-use/not-in-use state, and the priorities and the control modes assigned to the application interfaces 1-1, 1-2, and 1-3 of the applications D, E, and F.

FIG. 16 illustrates a procedure to determine the detailed parameter determination signal 33 supplied to the wireless transmission circuit 5, from the intermediate process signal determined as shown in FIG. 15 and the information from the system interface 6. The system interface 6 includes the area information L-3, the information of the state of electric wave reception L-1, the remaining battery resource information L-2 and the like. The area information L-3 indicates the level of an electric wave environment of the device. For instance, the level is low in a small room of 10 m square, while the level is high in a room larger than the room of 10 m square. The remaining battery resource information L-2 indicates the remaining battery resource, and is one of the following four states: state of AC drive, state of high remaining battery resource, state of middle remaining battery resource, and state of low remaining battery resource. The information of the state of electric wave reception L-1 indicates information regarding the channel. The information of the state of electric wave reception L-1 indicates, for instance, the electric wave strength in a given environment, and is either high or low.

Next, the following will provide a detailed description of a procedure to determine the detailed parameter determination signal 33 for determining the detailed parameter such as the operation mode of the wireless transmission circuit 5, by the following two steps.

As FIG. 15 exemplifies, in the first step, the control mode (i.e. the above-mentioned intermediate process signal) in each period is determined with reference to the application interface 1. As FIG. 16 exemplifies, in the second step, the detailed parameter 26 for controlling the wireless transmission circuit 5 is determined with reference to the control mode determined in the first step, the feedback information from the system interface 6, and the like.

First, with the assumption that the horizontal axis indicates time, the power management determination circuit 3 determines the control mode (intermediate process signal) of each period, with reference to the states of use of the applications D through F. The application interface 1-1 of the application D is arranged such that the priority is 1 and the control mode is in the power-off control mode. The application interface 1-2 of the application E is arranged such that the priority is 2 and the control mode is in the pre-selection receiving control mode. The application interface 1-3 of the application F is arranged such that the priority is 3 and the control mode is in the variable beacon interval control mode. In the first period from a time t0 to a time t1, the applications D, E, and F are all in use. In the second period from the time t1 to a time t2 (t2>t1), the applications E and F are in use. In the third period from the time t2 to a time t3 (t3>t2), the application F is in use. In this case, in the first step, the power-off control mode which is the control mode of the application D having the highest priority (1) is selected in the first period. In the second period, the pre-selection receiving control mode which is the control mode of the application E having the highest priority (2) in that period is selected. In the third period, the variable beacon interval control mode which is the control mode of the application F operating in that period is selected.

In this manner, in the power management determination circuit 3, a control mode of an application which is in use in that period and has the highest priority is selected as the control mode of the period, and this control mode is, as the intermediate process signal, used in the second step.

Next, with the assumption that the horizontal axis indicates time, the power management determination circuit 3 determines the detailed parameter determination signal 33 supplied to the wireless transmission circuit 5, with reference to the intermediate process signal obtained from the states of use of the applications D through F, the feedback information from the system interface 6, and the like. As shown in FIG. 16, the detailed parameter determination signal 33 is determined with reference to the area information L-3, the information of the state of electric wave reception L-1, the remaining battery resource information L-2, and the command L-4 of the system interface 6, in addition to the intermediate process signal determined in the first step.

This detailed parameter determination signal 33 is supplied to the wireless transmission circuit 5, so that the operation mode, the power management, the transmission output level control, and the reception sensitivity level control, which are items of the detailed parameter 26 of the wireless transmission circuit 5, are determined.

That is to say, with reference to the intermediate process signal which is the control mode of each period determined in the first step, the feedback information from the system interface 6 and the like, the power management determination circuit 3 determines the detailed parameter determination signal 33 of each operation period, the signal 33 being supplied to the wireless transmission circuit 5. The operation mode of the detailed parameter determination signal 33 is set so as to be identical in terms of the mode with the intermediate process signal which is the control mode of each period. Note that, however, when, upon the drive of the battery, the remaining battery resource is less than a predetermined amount, the power management determination circuit 3 compulsorily changes the operation mode of the detailed parameter determination signal 33 to the power-off operation mode. Such a compulsory change of the operation mode is effective because how much battery resource still remains is the most important matter in, for instance, mobile devices.

The power management determination circuit 3 determines the transmission output level control and the reception sensitivity level control, in accordance with the area information L-3 and the information of the state of electric wave reception L-1. That is to say, the power management determination circuit 3 determines the transmission output level control, in accordance with the area information L-3 on the system interface 6. Also, the power management determination circuit 3 determines the reception sensitivity level control, in accordance with the information of the state of electric wave reception L-1 on the system interface 6. Note that, the area information L-3 and the command L-4 on the system interface 6 may be automatically determined or may be determined by the user.

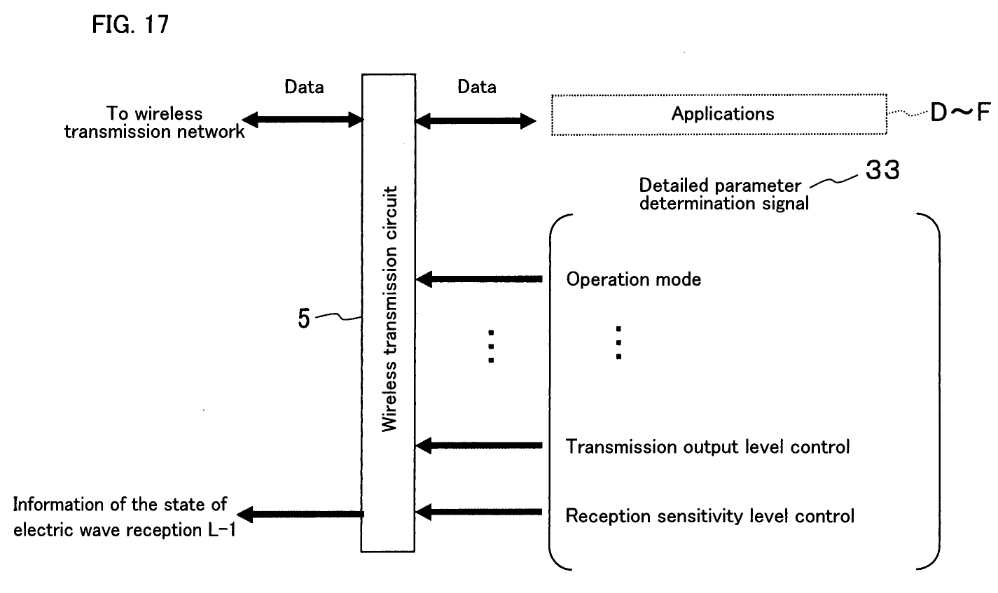

FIG. 17 outlines the process by the wireless transmission circuit 5. In accordance with the supplied detailed parameter determination signal 33 indicating the operation modes of applications, the transmission output level control, the reception sensitivity level control and the like, the wireless transmission circuit 5 transfers data from each application to the wireless transmission network, receives data from the wireless transmission network, and transmits data to each application as the need arises.

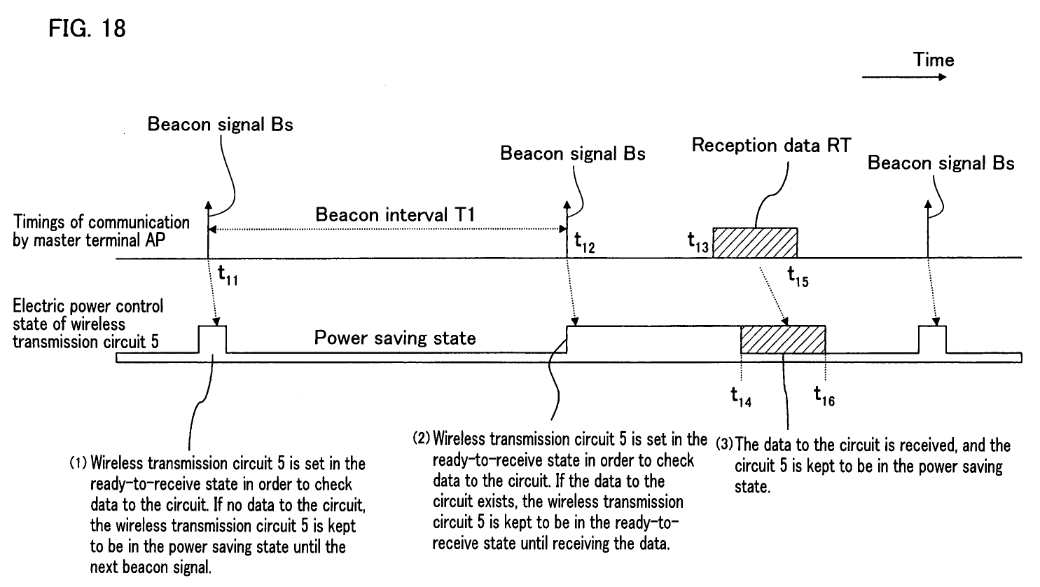

Now, with reference to FIGS. 18-21, the following will specifically describe the power saving operation of the wireless transmission circuit 5 in each operation mode shown in FIG. 14.

FIG. 18 shows an example of the power saving operation of the wireless transmission circuit 5 in the constant beacon interval operation mode. As in the figure, when the wireless transmission circuit 5 receives a beacon signal BS at a time t11, the wireless transmission circuit 5 becomes ready to receive data, in order to check the presence of data addressed to the circuit 5. If there is no data addressed to the circuit 5, the power saving state is held until the next beacon signal is supplied (i.e. for a beacon interval T1 (=t12-t11)). Upon the reception of the next beacon signal BS (at a time t12), the wireless transmission circuit 5 is set to ready to receive data, in order to check the presence of data addressed to the circuit 5. If there is data addressed to the circuit 5, the wireless transmission circuit 5 holds the ready-to-receive state until actually receiving that data.

If reception data RT is dispatched during a period from a time t13 to a time t15, the wireless transmission circuit 5 receives the reception data RT after a certain delay time has passed, i.e. the wireless transmission circuit 5 receives the reception data RT during a period from a time t14 to a time t16. Subsequently, the wireless transmission circuit 5 holds the power saving state until receiving the next beacon signal BS. In this manner, the power saving operation in the constant beacon interval control mode is carried out in such a manner that, the beacon signal supplied from the master terminal AP- at predetermined intervals is received, and by means of this beacon signal BS, it is possible to perceive, before receiving the next beacon signal BS, whether or not the reception data RT stored in the master terminal AP is supplied to the wireless transmission circuit 5. Therefore, from (i) the time t12 or (ii) a time t12′, which is a point of time after a predetermined period elapses from the time t12 to a time at which the next beacon signal BS is received, the wireless transmission circuit 5 holds the ready-to-receive state. In this manner, the power saving operation is performed.

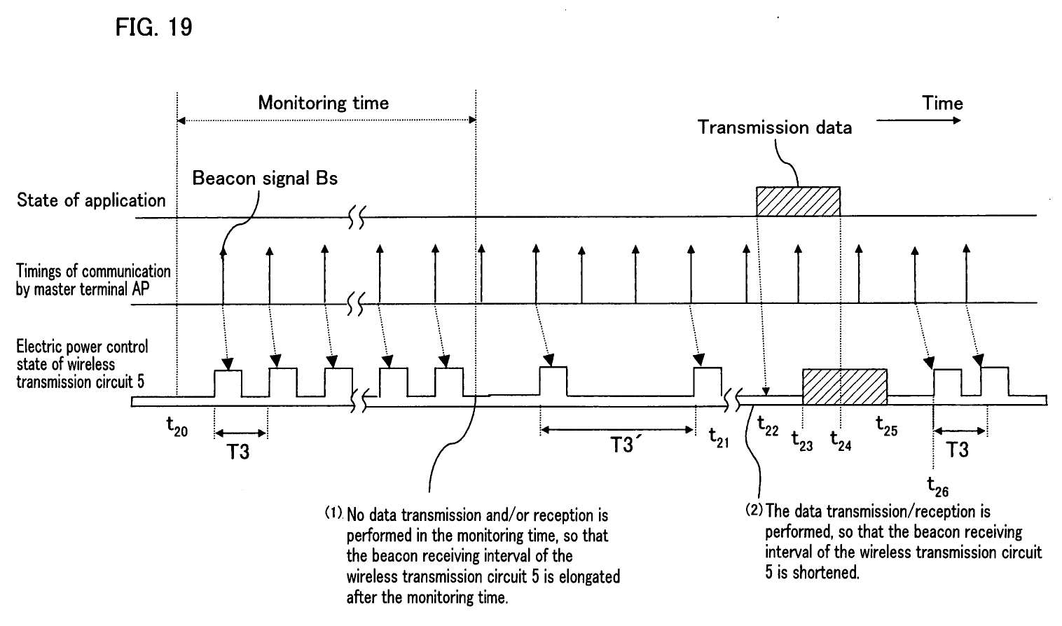

FIG. 19 shows an example of the power saving operation of the wireless transmission circuit 5 in the variable beacon interval operation mode. In this operation mode, if no data transmission and/or reception is performed during a monitoring time, the beacon receiving interval (T3′) of the wireless transmission circuit 5 is elongated. Note that, however, if the data transmission and/or reception is performed after elongating the beacon receiving interval, the beacon receiving interval is shortened. As shown in FIG. 19, provided that the beacon receiving interval is T3 from a time t20 to the end of the monitoring time, the beacon receiving interval is changed if no data transmission and/or reception is performed in this period. If, for instance, transmission data is received, the next beacon receiving interval is caused to return to the original interval T3. On this occasion, the beacon receiving interval T3 may be elongated or shortened. Also, after being changed, the beacon receiving interval T3 may be allowed to return to the original interval.

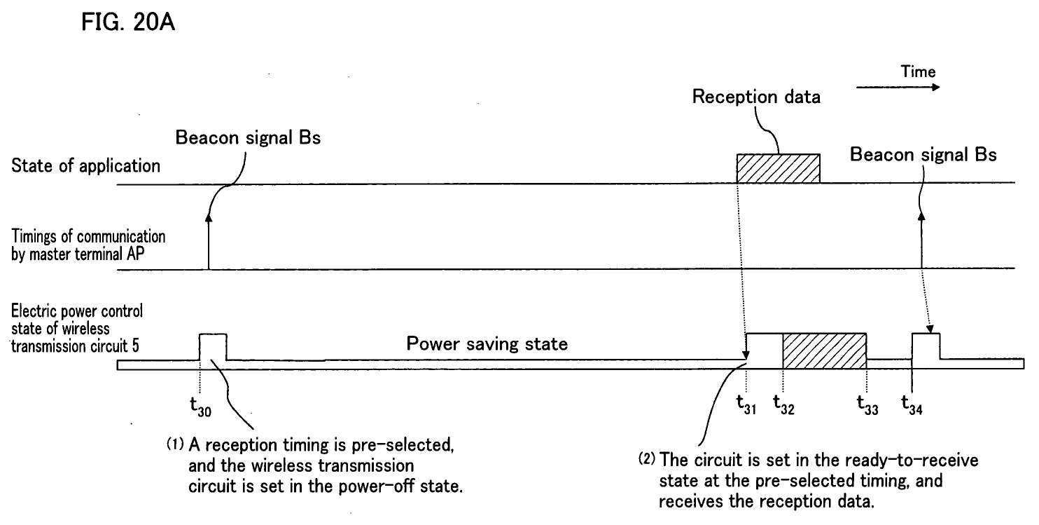

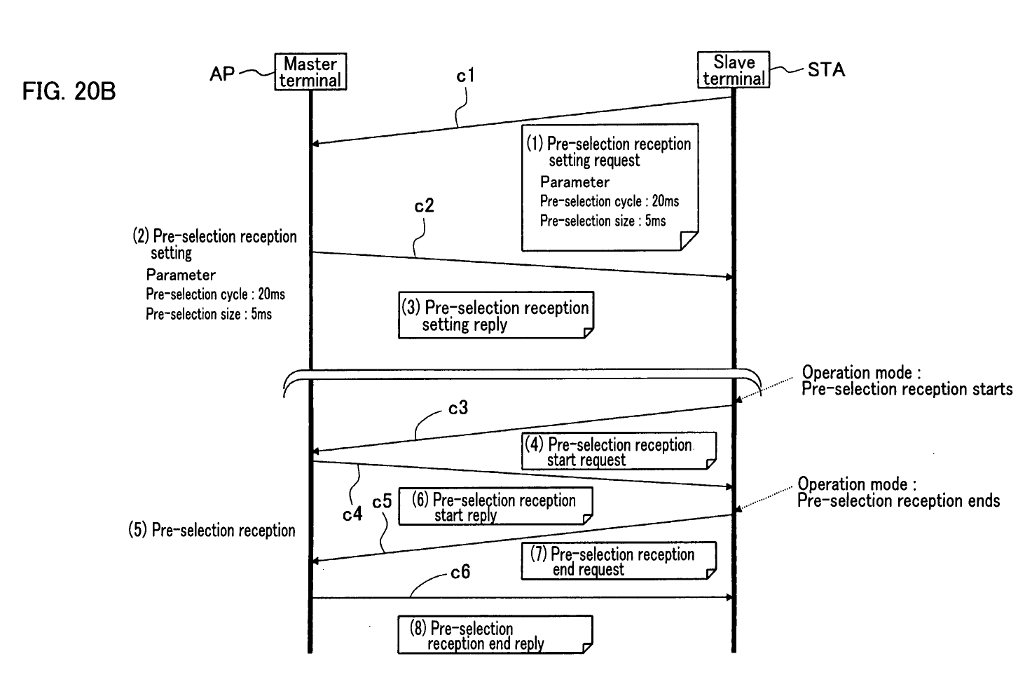

With reference to FIGS. 20A and 20B, the pre-selection receiving operation is described. FIG. 20A shows the power saving operation of the wireless transmission circuit 5 in the mode of the pre-selection receiving operation. FIG. 20B shows the setting sequence of the pre-selection receiving operation.

The reception period is pre-selected in the master terminal AP, and the receiving operation is performed only during this reception period, so that the power saving is realized. The setting sequence of the pre-selection receiving operation shown in FIG. 20B is provided for setting the reception period by exchanging signals between the master terminal AP and the slave terminal STA. First, the slave terminal STA sends pre-selection reception setting request C1 to the master terminal AP. The parameter of this pre-selection reception setting request C1 on this occasion is a pre-selection cycle of 20 ms and a pre-selection size of 5 ms. Then the master terminal AP having received the parameter from the slave terminal STA performs the pre-selection reception setting. Subsequently, the master terminal AP sends pre-selection reception setting reply C2 to the slave terminal STA, so that the pre-selection reception setting in the master terminal AP finishes, and the master terminal AP waits for pre-selection reception start request C3 from the slave terminal STA.

If the pre-selection receiving control mode is selected as the detailed parameter of the slave terminal STA, the pre-selection reception start request C3 is supplied to the master terminal AP, and the master terminal AP returns pre-selection reception start reply C4 to the slave terminal STA. Then the pre-selection receiving process is performed in the master terminal AP. If the detailed parameter of the slave terminal STA is switched to a power-off operation mode from the pre-selection receiving operation, the slave terminal STA sends pre-selection reception end request C5 to the master terminal AP, and in response to this, the master terminal AP sends pre-selection reception end reply C6 to the slave terminal. This is the end of the above-described series of operations.

As described above, the pre-selection receiving process in the master terminal AP is performed in such a manner that, on the basis of the beacon interval of 100 ms, a time interval of 5 ms is counted in every 20 ms, and each period of 5 ms is pre-selected as the data processing time of the slave terminal STA. The slave terminal STA receives the beacon signal BS at the time t30. Then the slave terminal STA figures out the timing at which the data reception is carried out using an internal timer, and a receiving period of 5 ms is provided at every 20 ms. Subsequently, the power source of the wireless transmission circuit 5 is caused to be in the power saving state. At the pre-selected time t31, the wireless transmission circuit 5 is caused to be in the ready-to-receive state, and receives the reception data during a period from a time t32 to a time t33. Subsequently, the power source of the wireless transmission circuit 5 is set to the power saving mode. At the pre-selected timing t31, the wireless transmission circuit 5 is caused to be in the ready-to-receive state, and receives the reception data during a period from a time t32 to a time t33. The power saving state is held from the time t30 to the time t31. Subsequently the power saving state lasts until the reception or the next pre-selected timing.

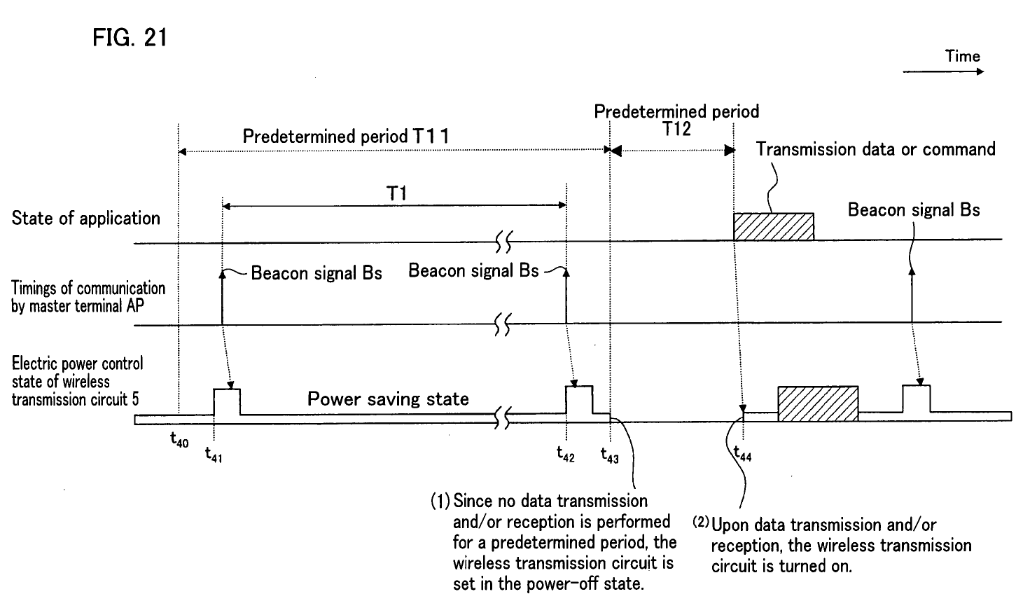

FIG. 21 shows an example of the power saving operation of the wireless transmission circuit 5 in the power-off operation mode.

In this power-off operation, if no data transmission and/or reception is performed during a predetermined period T11 (from a time t40 to a time t43), the power source of the wireless transmission circuit 5 is turned off during a period (T12) from a time t43 to a time t44. For instance, if, at the time t44, the wireless transmission circuit 5 receives any one of the transmission data, a signal for tuning on the power source, and a signal for tuning on the power management in the detailed parameter, the circuit 5 returns to the power-on-state or returns to the power saving state at the time t44.

In the passages above, representative operation modes of the device management system of the present embodiment of the present invention have been described. However, the present invention is not limited to the examples above, and the above-described operation modes may be appropriately combined with each other.

### EXAMPLE 1

Now, a more detailed example will be presented with reference to figures. First, preconditions and items to be determined are described. Applications running on a device of the present example are an application D (e-mail reception), an application E (browser), and an application F (VoIP).

A process regarding the e-mail reception is carried out in such a manner that, the presence of an e-mail in a mail server is checked at predetermined intervals (e.g. one minute), and if there is an e-mail, the mail reception is performed. On this occasion, the application interface 1-1 is arranged such that, for instance, the priority is “3” and the variable beacon interval control mode is selected as the control mode. In line with the variable beacon interval control mode, the power management determination circuit 3 determines the detailed parameter determination signal 33 so as to arrange the monitoring time to be 3 minutes and the beacon receiving interval to be one minute.

A process regarding the browsing is to allow the user to browse web pages using a browser. On this occasion, the application interface 1-2 is arranged in such a manner that the priority is “2” and the power-off control mode is selected as the operation mode. In line with this power-off control mode, the power management determination circuit 3 determines the detailed parameter determination signal 33 so as to arrange the monitoring time to be 3 minutes.

A process regarding the VoIP is to subject a voice signal to digital processing, and transmits and receives digital voice data at predetermined intervals (e.g. 20 ms). On this occasion, the application interface 1-3 is arranged such that, for instance, the priority is “1” and the pre-selection receiving control mode is selected as the control mode. In line with this pre-selection receiving control mode, the power management determination circuit 3 determines the detailed parameter determination signal 33 so as to arrange the beacon receiving interval to be 100 ms, the pre-selection cycle to be 20 ms, and the pre-selection size to be 10 ms.

The use environment of the device is AC adopter/battery drive. According to this method, when, for instance, used away from home in a mobile manner, if an AC adopter is removed, the driving method is automatically switched to the battery drive. The distance between a device (slave terminal STA) and a master terminal AP is short (the present case assumes a typical wireless LAN-environment in which the connection to the Internet is conducted via an access point of the wireless LAN). The operating system (e.g. OS) of the device or application software is arranged so as to perform the output of a timing signal indicating start or stop, so that the application interface 1 reports the state of use of the application to the power management determination circuit 3.

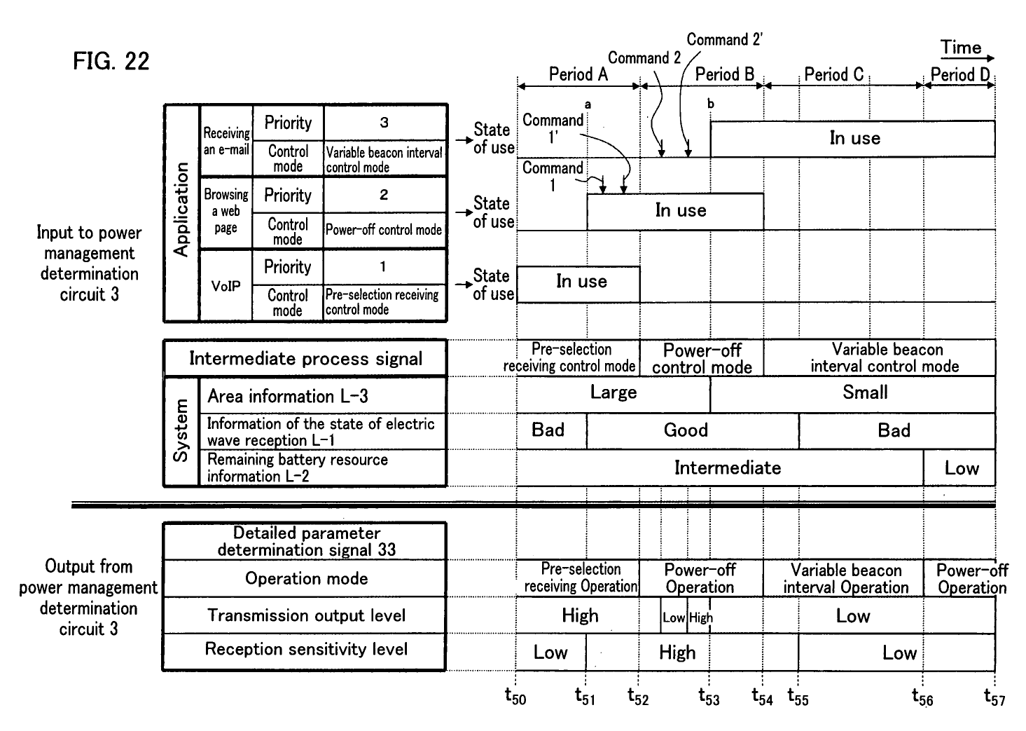

FIG. 22 shows the relationship between the operation of the application and the power management, and illustrates an input signal and an output signal of the power management determination circuit 3.

As in this figure, under the conditions set forth above, the following applications are used: the e-mail reception, web-page browsing, and VoIP.

In FIG. 22, a horizontal axis indicates time, while a vertical axis indicates an input signal from the application interface 1 and the system interface 6 to the power management determination circuit 3 and an output signal from the power management determination circuit 3 (i.e. the detailed parameter determination signal 33 determined by the power management determination circuit 3).

From a time t52 to a time t52 (period A), the VoIP is in use. At a time t51(a) during this period, the web-page browsing starts, and continues to run until a time t54.

A period from a time t52 to a time t54 is termed period B. At a time t53(b) during this period B, the e-mail reception starts and continues to run until a time t57.

Next, a process of determining the intermediate process signal (intermediate process signal in the process of the power management determination circuit 3 in the above-mentioned step 1) in the period A (from t50 to t52) will be described. The process in the period from the time t50 to the time t51 is described first, and then the process in the period from the time t51 to the time t52 is described.

In the period from t50 to t51, an application whose state of use is “in use” is the VoIP, so that the intermediate process signal is set to the pre-selection receiving control mode, with reference to the control mode of the application interface 1-3 of the VoIP.

In the period from t51 to t52, the VoIP and the web-page browsing are “in use”. The priority of the application interface 1-3 of the VoIP is “1” so that the application interface 1-3 takes precedence over the application interface 1-2 of the web-page browsing, which has the priority of “2”. On this account, the intermediate process signal is set to the pre-selection receiving control mode, with reference to the control mode of the application interface 1-3 of the VoIP.

Next, a process of determining the intermediate process signal in the period B (from t52 to t54) will be described. The process in the period from the time t52 to the time t53 is described first, and then the process in the period from the time t53 to the time t54 is described.

In the period from t52 to t53, an application whose state of use is “in use” is the web-page browsing, so that the intermediate process signal is set to the power-off control mode, with reference to the control mode of the application interface 1-2 of the web-page browsing.

In the period from t53 to t54, the web-page browsing and the e-mail reception are “in use”. The priority of the application interface 1-2 of the e-mail reception is “2” so that the application interface 1-2 takes precedence over the application interface 1-1 of the e-mail reception, which has the priority of “3”. Therefore, the intermediate process signal is set to the power-off mode, with reference to the control mode of the application interface 1-2 of the web-page browsing.

Next, a process of determining the intermediate process signal in the period C (from t54 to t56) is described.

In the period from t54 to t56, the application whose state of use is “in use” is the e-mail reception, so that the intermediate process signal is set to the variable beacon interval control mode with reference to the control mode of the application interface 1-1 of the e-mail reception.

Next, a process of determining the intermediate process signal in the period D (from t56 to t57) is described.

In the period from t56 to t57, the application whose state of use is “in use” is the e-mail reception, so that the intermediate process signal is set to the variable beacon interval control mode with reference to the control mode of the application interface 1-1 of the e-mail reception.

With reference to FIG. 22, the area information L-3 of the system interface 6 is described.

In the figure, it is assumed as follows: the distance between the master terminal AP and the device of the present example is long in the period from t50 to t53. At the time t53, the distance between the master terminal AP and the device is reduced. Recognizing the reduction of the distance, the user sets the area information L-3 of the system interface 6 to “small”.

With reference to FIG. 22, the information of the state of electric wave reception L-1 of the system interface 6 is described.

The information of the state of electric wave reception L-1 is appropriately changed. For instance, before t51, the information of the state of electric wave reception L-1 is “bad”. In the period from t51 to t55, the information of the state of electric wave reception L-1 is “good”. After t55, the information of the state of electric wave reception L-1 is “bad”. Note that, this information of the state of electric wave reception L-1 is figured out by and outputted from the receiver circuit 25 of the wireless transmission circuit 5.

With reference to FIG. 22, the remaining battery power information L-2 of the system interface 6 is described. Until t56, the remaining battery power information L-2 is “intermediate”, after t56, the remaining battery power information L-2 is “low”. Note that, this remaining battery power information L-2 is figured out in accordance with the resource of the battery 11 and is outputted.

In accordance with the intermediate process signal and the area information L-3, the information of the state of electric wave reception L-1, and the remaining battery power information L-2 obtained from the system interface 6, the power management determination circuit 3 outputs the detailed parameter determination signal 33. Now, with reference to FIG. 22, a process of determining this detailed parameter determination signal 33 is described.

The operation mode indicated by the detailed parameter determination signal 33 is determined with reference to the intermediate process signal and the remaining battery power information L-2. More specifically, when the remaining battery power information L-2 is “low”, the operation mode is compulsorily switched to the power-off operation. Meanwhile, when the remaining battery power information L-2 is not “low”, the operation mode is determined with reference to the intermediate process signal. That is to say, when the intermediate process signal indicates the normal control mode, the normal operation is selected as the operation mode. When the intermediate process signal indicates the pre-selection receiving control mode, the pre-selection receiving operation is selected as the operation mode. When the intermediate process signal indicates the constant beacon interval control mode, the constant beacon interval operation is selected as the operation mode. When the intermediate process signal indicates the variable beacon interval control mode, the variable beacon interval operation is selected as the operation mode. When the intermediate process signal indicates the power-off control mode, the power-off operation is selected as the operation mode.

Therefore, the pre-selection receiving operation is performed in the period A (from t50 to t52), the power-off operation is performed in the period B (from t52 to t54), the variable beacon interval operation is performed in the period C (t54 to t56), and the power-off operation is performed in the period D (from t56 to t57).

FIG. 22 also shows a process concerning the commands described in reference to FIG. 12. With regard to the command determined by each application, the power management determination circuit 3 determines the detailed parameter determination signal 33 in an interruptive manner, in accordance with the priority and the state of use indicated by the application interface 1. As shown in FIG. 22, for instance, at a timing before a time point b in the period B, the application of web-page browsing generates a transmission output level control command (command 2) for decreasing the transmission output level and a transmission output level control command (command 2′) for increasing the transmission output level after decreasing the level. These commands are supplied to the power management determination circuit 3. In the present case, in accordance with this pair of commands, the power management determination circuit 3 changes the transmission output level of the detailed parameter determination signal 33 from high to low, during a period indicated by the pair of commands. Then, in accordance with the latter command 2′, the power management determination circuit 3 changes the transmission output level from low to high.

In the meanwhile, in the period from t51 to t52, in a similar manner, the application of the web-page browsing generates a transmission output level control command (command 1) for decreasing the transmission output level and a transmission output level control command (command 1′) for increasing the transmission output level after decreasing the same. These commands are supplied to the power management determination circuit 3. In this case, the priority (1) of the application interface 1-3 of the VoIP is higher than the priority (2) of the application interface 1-2 of the web-page browsing, so that the detailed parameter determination signal 33 is not changed at all with regard to the transmission output level control, and the transmission output level control “high” determined in accordance with the area information L-3 is outputted. In this manner, the command of the application interface 1 of the application determines whether or not the interruptive process is carried out with reference to the priority and the like. In the meantime, the command of the system interface 6 is used for performing the process concerning the command in an interruptive manner, regardless of the priority and the like. With this, a desirable electric power management process is carried out not only by the pre-selected mode control of the application interface 1 but also by the commands outputted in response to the input from the user.

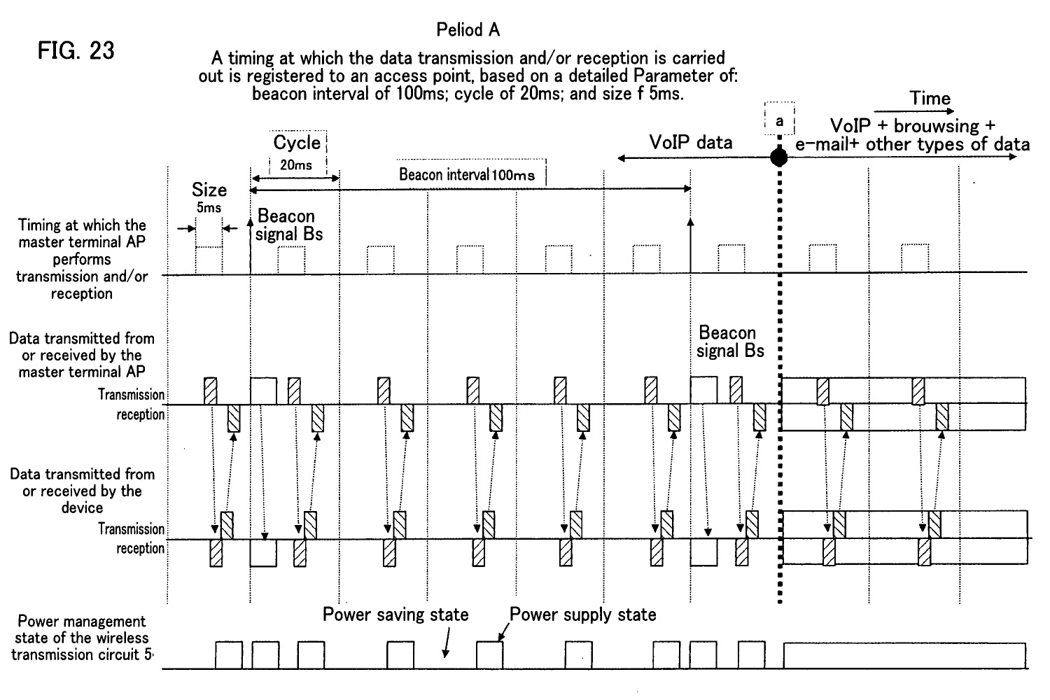

Now, the period A shown in FIG. 22 is described in detail with reference to FIG. 23. In the period A, with reference to the detailed parameter determination signal 33 (operation mode: pre-selection receiving operation, pre-selection cycle: 20 ms, pre-selection size: 5 ms) supplied to the wireless transmission circuit 5, a timing at which the data transmission and/or reception is carried out as the pre-selection receiving operation is registered to the master terminal AP. As shown in FIG. 23, the beacon signal BS is dispatched from the master terminal AP at constant intervals of 100 ms. In this case, only the VoIP runs until the time a, so that the data from the master terminal AP and the data from the device (slave terminal STA) are alternately exchanged. For the meantime, the beacon signal at the intervals of 100 ms is transmitted and received. The electric power management state of the wireless transmission circuit 5 on this occasion is either (i) in the power supply state when data is exchanged and the beacon signal is received, or (ii) otherwise in the power saving state. At the timing a, the web-page browsing starts, so that two applications (the VoIP and the web-page browsing) run from this time forward and the power saving state is replaced with the power supply state. Note that, if the application for the web-page browsing stops the operation, the power supply state and the power saving state may be alternated again in accordance with the pre-selection receiving operation. To resume this alternation after the timing a has passed, the operations before the timing a, which have been described with reference to the figure, are performed again.

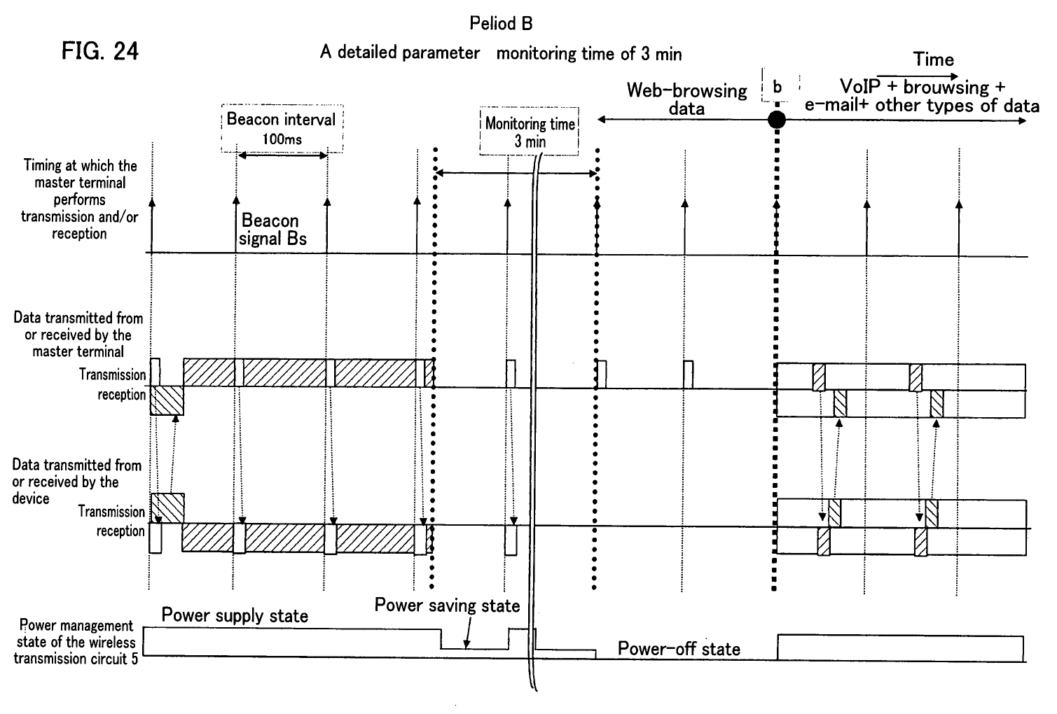

With reference to FIG. 24, the period B in which the web-page browsing and the e-mail reception run is described in detail. The detailed parameter determination signal supplied to the wireless transmission circuit 5 indicates as follows: the monitoring time: 3 minutes, the operation mode: power-off operation. When the user of the slave terminal STA clicks the URL of an web page, the slave terminal STA accesses the server of that web page via the master terminal AP, thereby allowing the user to browse the page. During the monitoring time (3 minutes) in which the user is browsing the web-page, if no data is transmitted and/or received, the wireless transmission circuit 5 controls the switches 27 and 30 of the transmitter circuit 21 and the receiver circuit 25 so as to turn off the wireless transmission circuit 5. If, during the monitoring time, the data transmission is carried out as another application starts or the user browses another web-page, the wireless transmission circuit 5 controls the switches 27 and 30 of the transmitter circuit 21 and the receiver circuit 25, causing the wireless transmission circuit 5 to be in the power supply state. In FIG. 24, a new application does not start during the monitoring time so that the power-off state starts after the monitoring time of 3 minutes passes. Subsequently, at a timing b, the e-mail reception application starts to run, so that the e-mail reception starts at this timing b. Therefore, the power supply state is resumed at this timing b.

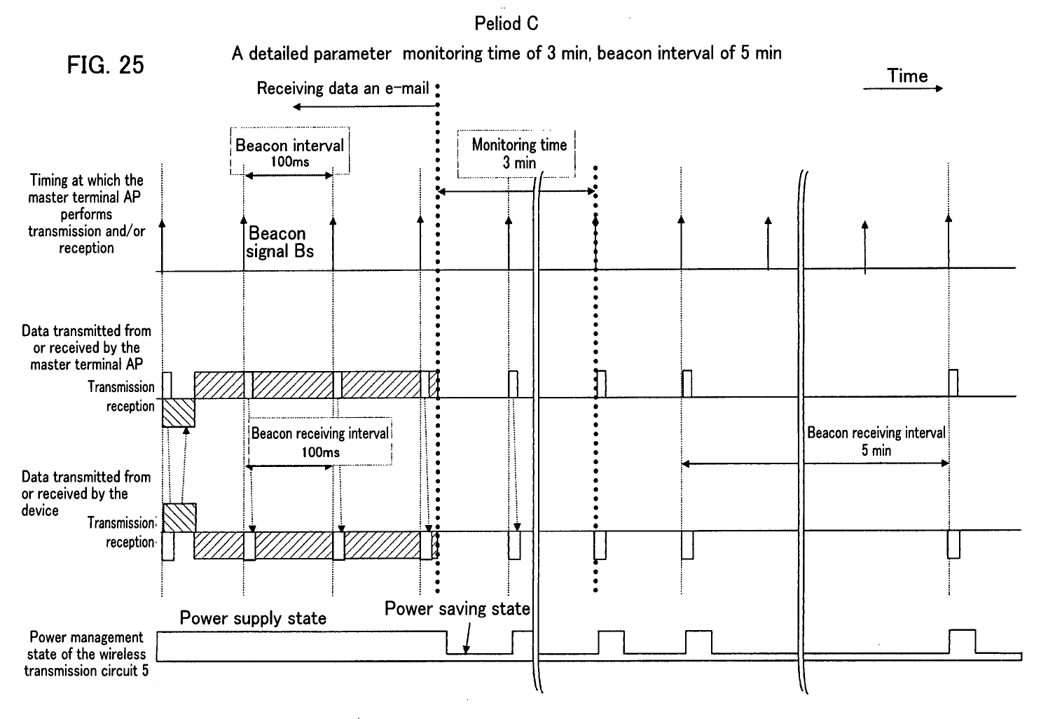

With reference to FIG. 25, the period C in which the e-mail reception is carried out is described in detail. The detailed parameter determination signal 33 supplied to the wireless transmission circuit 5 indicates as follows: the monitoring time: 3 minutes, the beacon receiving interval: 5 minutes, and the operation mode: constant beacon interval operation. In the initial stage, an address of a received e-mail and data for authentication are supplied from the master terminal AP to the slave terminal STA, and, for instance, an authentication password is returned from the slave terminal STA to the master terminal AP. Subsequently, the reception data of the e-mail is supplied from the master terminal AP to the slave terminal STA. While doing this data supply, the wireless transmission circuit 5 is in the power supply state. Provided that the reception of the e-mail reception data finishes and then no data transmission and/or reception is performed for not less than 3 minutes, the wireless transmission circuit 5 judges that no data transmission and/or reception is performed during the monitoring time (3 minutes) of the detailed parameter determination signal 33, and elongates the beacon receiving interval to 5 minutes which is defined by the detailed parameter determination signal 33. In this manner, the beacon receiving interval is elongated or shortened with reference to the presence of the transmitted/received data, so that the electric power management is performed in a subtler manner as comparing to the case of the constant beacon interval.

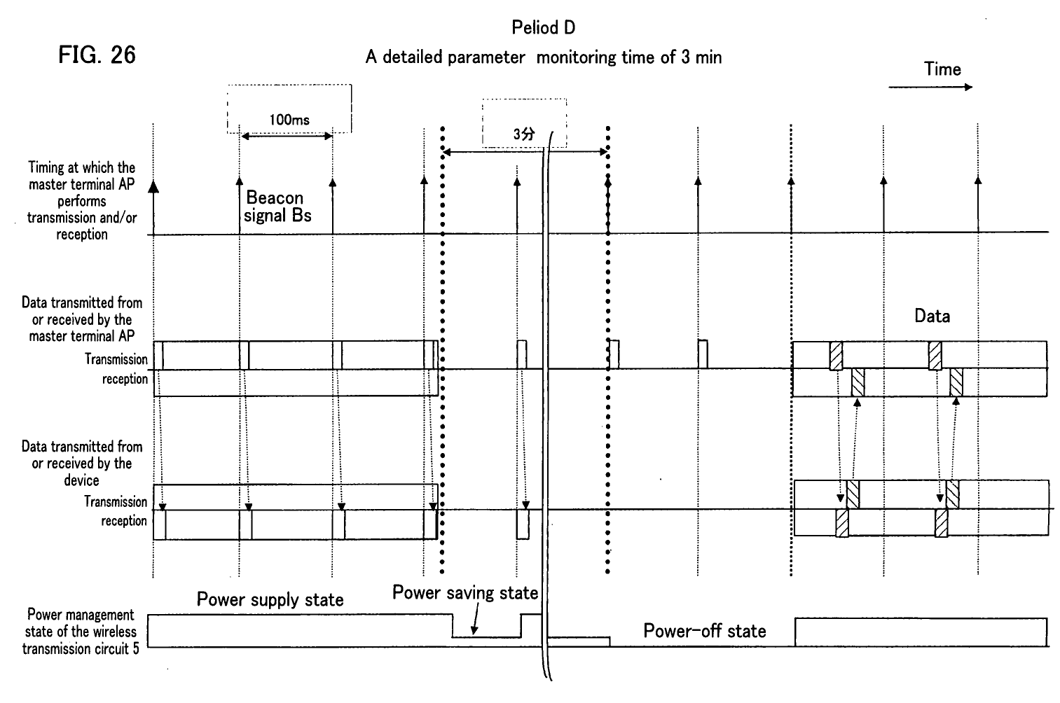

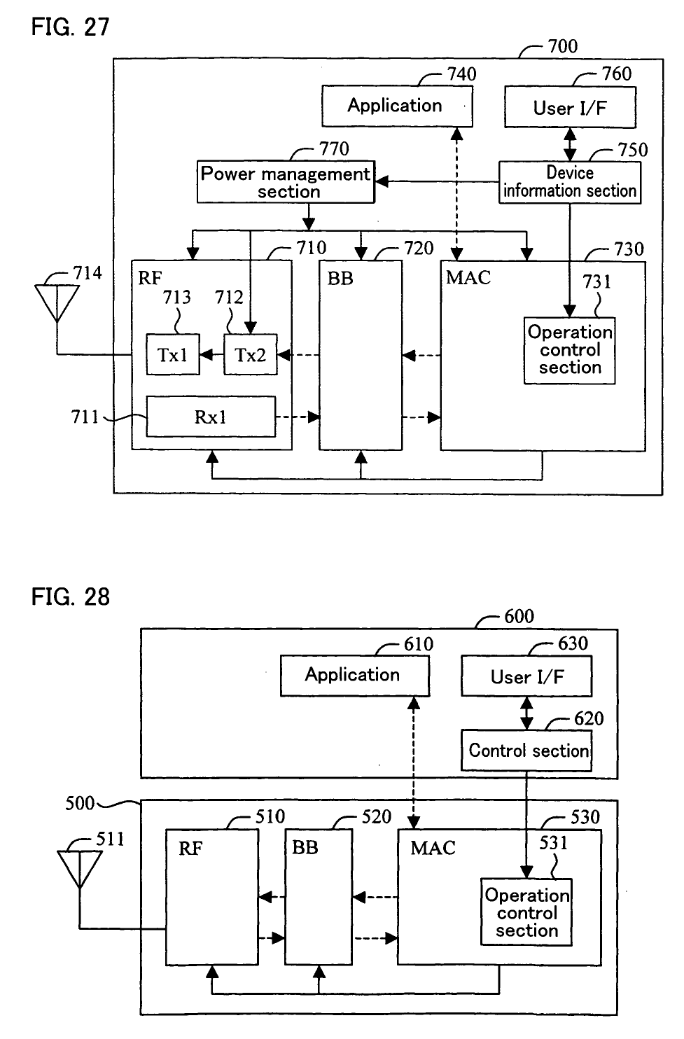

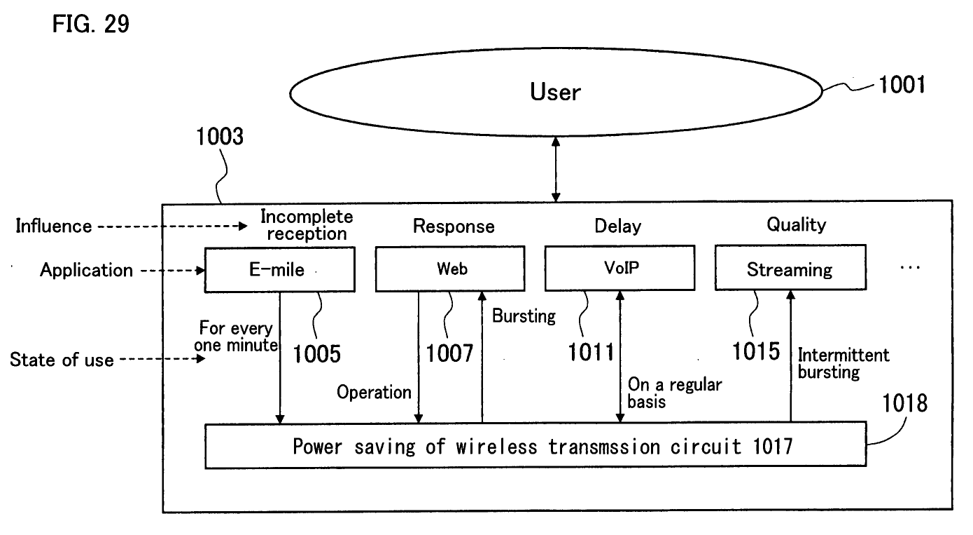

FIG. 26 shows the operation in the period D in detail. As in this figure, in the period D, the detailed parameter determination signal 33 supplied to the wireless transmission circuit 5 indicates as follows: the monitoring time: 3 minutes, and the operation mode: power-off operation. In the period D, the application of the e-mail reception runs. When no data is received after the monitoring time (3 minutes) passes, the user is notified, via either an image on an LED and a display or sound, that the battery power is low. This allows the user to charge the battery or safely stop the device after, for instance, transferring the data in the device to elsewhere. If the user does not notice the notification, the power-off control is forcibly performed in order to maximize the drive time as much as possible.

The embodiments and example of the present invention have been described above. The present invention may be varied in many ways. For instance, although a mobile PC is taken as an example in the embodiments above, the present invention can be applied for devices with a wireless LAN function such as a mobile phone and a PDA.

In the embodiments above, a plurality of applications D, E, and F are provided. However, the number of the application may be only one. As the period C, the period D, and the period from t52 to t53 exemplify, even if only one application is provided, the power management determination circuit 3 can determine the operation mode, the transmission output level, and the reception sensitivity level which are suitable for the power saving, with reference to the information of the state of electric wave reception L-1, the remaining battery power information L-2, the area information L-3, or the command. In this manner, the power consumption of the device Z can be reduced.

The information processing device of the present embodiment includes the wireless transmission circuit 5 which performs, as a communication device, wireless communications. However, the wireless circuit 5 may be a communication device which performs wired communications. When performing the wired communications, the power management determination circuit 3 determines the detailed parameter determination signal, with reference to at least one of the information regarding a wired channel (i.e. channel information) and the remaining battery power information.

In the descriptions above, it has been assumed that the state of use of an application indicates whether or not the application is activated. Alternatively, it is possible to assume that the state of use of an application indicates whether or not a particular process of the application is activated. For instance, in the case of the application of the web-page browsing, the state of use is “in use” on the occasion of downloading the data of the web page, while the state of use of “not in use” when the user is watching the web page. With this, the power management determination circuit 3 can output the detailed parameter determination signal corresponding to the process being currently carried out by the application.

An information processing system including a plurality of devices Z may be constructed. When the devices Z can communicate each other by air or by wires, the pre-selection cycle and the pre-selection size included in the detailed parameter determined by the power management determination circuit 3 in order to control the wireless transmission circuit 5 of one of the devices Z may be adopted as the pre-selection cycle and the pre-selection size of another one of the devices Z. For instance, when one of the devices Z is a slave terminal and the other of the devices Z is a master terminal, the slave terminal and the master terminal can share an identical pre-selection cycle and an identical pre-selection size.

In this manner, according to one aspect of the present invention, it is possible to provide an information processing device characterized by including: a wireless transmission circuit; at least one application; and a power management determination circuit which determines a control signal supplied to the wireless transmission circuit, with reference to the information obtained from the use environment of the device.

Furthermore, there is provided an information processing device characterized by including a wireless transmission circuit, at least one application, and a power management determination circuit which determines a control signal supplied to the wireless transmission circuit, with reference to at least one of (i) the state of use of the application and (ii) information obtained from a control mode which relates to electric power management and is determined in each of the applications. With this, the adjustment regarding the electric power management is realized even if the information processing device involves more than one element defining the use environment. The control is preferably carried out without causing any significant problems with regard to the power saving and the application.

During the period in which a plurality of applications run, each application includes information of priority of the application regarding the electric power management. With this, the power saving control can be realized also in the situation that a plurality of applications run.

The information obtained from the use environment of the wireless transmission circuit includes electric power supply information indicating power supply to the wireless transmission circuit. When the electric power supply information includes the remaining battery resource information at the time of battery drive, and the remaining battery resource is fewer than a predetermined remaining battery resource, the control signal supplied to the wireless transmission circuit is determined based primarily on this electric power supply information.

A power amplifier provided in the wireless transmission circuit is controlled by a signal generated in accordance with the transmission output level control of the detailed parameter. Also, a low-noise amplifier provided in the wireless transmission circuit is controlled by a signal generated in accordance with the reception sensitivity level control of the detailed parameter. With the transmission power amplifier or the low-noise amplifier, the change of the transmission output level or the reception sensitivity level can be supported. Furthermore, the application has a command for determining the timing of performing the electric power management in an interruptive manner, in addition to the information such as the control mode which relates to the electric power management and is determined in each application. The command is at least either: (i) a command regarding the switching of the power supply to the transmitter circuit and/or the receiver circuit concerning the wireless transmission circuit or (ii) a command regarding the switching of the transmission output level and/or the reception sensitivity level.

Using the command, the process similar to that of the control mode which is arranged in advance can be appropriately performed in response to the instruction from the user. Appropriately using the control mode and/or the command, the electric power management can be performed in a subtler manner.

According to another aspect of the present invention, an information processing device including a power management determination circuit includes a wireless transmission circuit, a plurality of applications, a plurality of application interfaces for the input to the wireless transmission circuit, and a system interface, the information processing device being characterized in that, the power management determination circuit determines a control mode of each period of the wireless transmission circuit, with reference to the input through the application interface, and also determines a detailed parameter determination signal of the wireless transmission circuit, with reference to the control mode and an input through the system interface.

With the information processing device of the present invention, the adjustment with regard to the electric power management is appropriately performed, even if one or more application(s) run on one device or on a plurality of devices being connected to each other. The control mode is selected in accordance with the communication properties concerning the power consumption, which is required by the application. Therefore, in accordance with the relationship between the application and the communication, the control can be performed without causing any significant problems regarding the power saving and application, e.g. incomplete reception.

Note that, in the embodiments above, the processing steps of the profile controller 100 or the power management determination circuit 3 can be realized in the following way: computing means such as a CPU executes a program stored in storing means such as a ROM (Read Only Memory) and RAM, so as to control input means such as a keyboard, output means such as a display, and communication means such as an interface circuit. Therefore, the functions and processes of the profile controller 100 or the power management determination circuit 3 of the embodiments above are realized, only by causing a computer including the above-mentioned means to read the program from a storage medium and execute the program. Furthermore, storing the program in a removable storage medium, it is possible to realize the aforesaid functions and processes by an arbitrary computer.

The storage medium may be a memory (not shown) for process steps on a microcomputer. For example, the program medium is something like a ROM. Alternatively, the program medium may be such that a program reader device (not shown) as an external storage device may be provided in which a storage medium is inserted for reading.

In addition, in any case, the stored program is preferably executable on access by a microprocessor. Further, it is preferred if the program is retrieved, and the retrieved program is downloaded to a program store area in a microcomputer to execute the program. The download program is stored in a main body device in advance.

In addition, the program medium may be a storage medium constructed separably from a main body. The medium may be tape based, such as a magnetic tape or cassette tape; disc based, such as a flexible disc or hard disk including a magnetic disc and CD/MO/MD/DVD; card based, such as an IC card (including a memory card); or a semiconductor memory, such as a mask ROM, EPROM (Erasable Programmable Read Only Memory), EEPROM (Electrically Erasable Programmable Read Only Memory), and a flash ROM. All these types of media hold the program in a fixed manner.

In contrast, if the system is arranged to connect to the Internet or other communication network, the medium is preferably a storage medium which holds the program in a flowing manner so that the program can be downloaded over the communication network.

Further, if the program is downloaded over a communication network in this manner, it is preferred if the download program is either stored in a main body device in advance or installed from another storage medium.

As described above, an information processing device of the present invention comprises: a communication device; an electronic device which executes at least one application; and a control device which determines a control signal supplied to the communication device, in accordance with first information supplied from the electronic device.

According to this arrangement, in addition to the communication device and the electronic device, the control device for controlling the communication device is provided. With this, the application does not necessarily include a special program for controlling electric power of the communication device. Furthermore, since the communication device is controlled by the control device in accordance with the first information (e.g. information indicating whether or not the application is in operation) supplied from the control device, the communication device is highly versatile and thus can be adopted to different types of electronic devices. For this reason, even a multipurpose communication device which can be manufactured at low costs thanks to volume efficiency can realize a low-power-consumption operation most appropriate to a use environment of the device.

The information processing device of the present invention is preferably arranged in such a manner that, the control device determines the control signal, further in accordance with second information supplied from the communication device.

According to this arrangement, the control device can control the communication device in an optimum manner, in accordance with the second information (e.g. information indicating the state of the channel) supplied from the communication device.

An information processing device in accordance with the present invention comprises: a communication device; an electronic device which executes at least one application; and a control device which determines a control signal supplied to the communication device, in accordance with second information supplied from the communication device.

According to this arrangement, in addition to the communication device and the electronic device, the control device for controlling the communication device is provided. With this, the application does not necessarily include a special program for controlling electric power of the communication device. Furthermore, since the communication device is controlled by the control device in accordance with the second information (e. g. information indicating the state of the channel). For this reason, even a multipurpose communication device which can be manufactured at low costs thanks to volume efficiency can realize a low-power-consumption operation most appropriate to a use environment of the device.

Furthermore, the control device preferably determines the control signal, further in accordance with first information supplied from the electronic device.

According to this arrangement, the control device can control the communication device in an optimum manner, in accordance with the first information (e.g. information indicating whether or not the application is in operation) supplied from the electronic device.

Furthermore, the first information preferably includes information which relates to either a state of use of said at least one application or a control mode regarding electric power management determined for each application.

The state of use of the application indicates, for instance, whether or not the application is in operation and whether or not a specific process of the application is activated. Whether or not a specific process of the application is activated is described, for instance, in the following manner: In the case of the application of the web-page browsing, the state of use is “in use” on the occasion of downloading the data of the web page, while the state of use of “not in use” when the user is watching the web page.

The control mode indicates an operation concerning electric power management. Examples of the control mode include: a pre-selection receiving control mode by which a timing at which data is received is determined in advance, and a power saving state is held until this timing; a power-off mode by which a power-off state starts when no data transmission and/or reception is performed for a predetermined period of time; and a variable beacon interval mode by which intervals of receiving a beacon signal are elongated when no data transmission and/or reception is performed for a predetermined period of time.

With the arrangement above, the communication device can be controlled in accordance with the state of use of the application or the control mode.

Furthermore, the second information preferably includes information regarding a use environment of the communication device.

The information regarding a use environment of the communication device is, for instance, information indicating the state of a channel and information indicating an amount of power supply to the communication device.

With this arrangement, the communication device can be controlled in accordance with the information regarding a use environment of the communication device.

Furthermore, the information regarding the use environment of the communication device is selected from at least one of: power supply information indicating electric power supplied to the communication device; and channel information indicating a current state of a channel.

According to this arrangement, the communication device can be controlled in accordance with the power supply information or the channel information.

Furthermore, the communication device is preferably a wireless communication device. Since the wireless communication device consumes relatively large amounts of power, the power saving effect by the control device is significant.

Furthermore, the information regarding the use environment of the communication device is preferably selected from at least one of: power supply information indicating electric power supplied to the communication device; channel information indicating a current state of a channel; and area information indicating an electric wave environment of the communication device.

According to this arrangement, the communication device can be controlled in accordance with any one of the power supply information, the channel information, and the area information. Note that, since the communication device is a wireless communication device, the channel information is, for instance, information of the state of electric wave reception, which indicates the state of electric wave reception.

Furthermore, it is preferable that, during a period in which more than one application run, the control device obtains, from each of said more than one application, priority information regarding electric power management, and determines the control signal in accordance with the priority information.

According to this arrangement, the power saving is realized even when a plurality of applications are in operation.

Furthermore, it is preferable that, the information regarding the use environment of the communication device is fed back to the control device, in accordance with a change of the use environment, and the control device updates the control signal supplied to the communication device, in accordance with the information being fed back.

According to this arrangement, the information regarding the use environment of the communication device is fed back to the control device, in accordance with a change of the use environment. With this, the control device can perform the power saving in accordance with the latest use environment of the communication device.

Furthermore, it is preferable that, the power supply information includes remaining battery resource at a time of driving a battery, and when the remaining battery resource indicates that a remaining battery power is lower than a predetermined level, the control signal supplied to the communication device is determined based primarily on the power supply information.

According to this arrangement, when the remaining battery power is lower than a predetermined level, it is possible to carry out the power saving most appropriate for the remaining battery power.

Furthermore, it is preferable that the control mode is selected in accordance with information regarding the electric power management, the electric power management being performed by the communication device in response to a request from an application concerning the control mode.

According to this arrangement, the communication device can be controlled in accordance with the electric power management performed by the communication device in response to a request from an application concerning the control mode.

Furthermore, it is preferable that the control signal supplied to the communication device is a signal for determining a detailed parameter of the communication device, the detailed parameter at least including transmission output level control, reception sensitivity level control, and power management.

According to this arrangement, the control device can perform the transmission output level control, the reception sensitivity level control, and the power management of the communication device.

Furthermore, by a signal generated in accordance with the power management of the detailed parameter, a power source of at least one of a transmitter circuit and a receiver circuit which are provided in the communication device is controlled.

Furthermore, by a signal generated in accordance with the transmission output level control of the detailed parameter, a power amplifier provided in the communication device is controlled.

Furthermore, by a signal generated in accordance with a the reception sensitivity level control of the detailed parameter, a low-noise amplifier provided in the communication device is controlled.

Furthermore, it is preferable that, apart from information such as a state of use and a control mode, each application has a command for determining, in an interruptive manner, a timing at which an electric power management is performed, and the control device determines the detailed parameter in accordance with the command.

Furthermore, it is preferable that the command includes at least one of: a command concerning switch-on/off of power supply to the communication device; and a command concerning a switch of a transmission output level and/or a reception sensitivity level.

According to this arrangement, using the command, a process similar to that of the control mode which is arranged in advance can be appropriately performed in response to the instruction from the user. Appropriately using the control mode and/or the command, the electric power management can be performed in a subtler manner.

An information processing device of the present invention includes: a communication device; an electronic device which executes at least one application, using the communication device; and a control device which controls the communication device, the information processing device further comprising: an application interface which supplies, to the control device, at least one of (i) information regarding a state of use of said at least one application and (ii) information regarding a control mode concerning an electric power management determined for each application; and a system interface through which information regarding a use environment of the communication device is inputted to the control device, and in accordance with an input from the application interface, the control device determining an intermediate process signal indicating a method of controlling the communication device in each period, while, in accordance with the intermediate process signal and an input from the system interface, a detailed parameter for controlling the communication device being determined.

A method of the present invention, which is for controlling electric power regarding an information processing device which includes a communication device and an electronic device which executes at least one application that performs communication using the communication device, comprises the steps of: determining an intermediate process signal indicating a method of controlling the communication device in each period, in accordance with at least one of (i) information regarding a state of use of said at least one application and (ii) information regarding a control mode concerning electric power management determined for each application; and controlling the communication device, in accordance with the intermediate process signal and information regarding a use environment of the communication device.

According to the aforementioned arrangement and method, in addition to the communication device and the electronic device, the control device for controlling the communication device is provided. With this, the application does not necessarily include a special program for controlling electric power of the communication device. Furthermore, the communication device is controlled by the control device in accordance with the state of use of the application and the control mode. For this reason, even a multipurpose communication device which can be manufactured at low costs thanks to volume efficiency can realize a low-power-consumption operation most appropriate to a use environment of the device.

A method of the present invention, which is for controlling electric power of an information processing device which includes a communication device and can execute at least one application, comprises: a first step of selecting, among applications in operation, an operation mode of an application which has the highest priority, as a method of controlling the communication device during a period of an operation of the application which has the highest priority; and a second step of outputting, to the communication device, a detailed parameter including the operation mode, a transmission output level, and a reception sensitivity level which correspond to the control method determined in the first step, in accordance with the control method determined in the first step and information including at least a channel state.

According to this method, in addition to the communication device and the electronic device, the control device for controlling the communication device is provided. With this, the application does not necessarily include a special program for controlling electric power of the communication device. Furthermore, the operation mode, the transmission output level, and the reception sensitivity level are determined in accordance with the priority of the application in operation and the state of the channel. For this reason, even a multipurpose communication device which can be manufactured at low costs thanks to volume efficiency can realize a low-power-consumption operation most appropriate to a use environment of the device.

An information processing system, comprises a plurality of information processing devices each including: a communication device; an electronic device which executes at least one application; and a control device which determines a control signal supplied to the communication device, in accordance with either first information supplied from the electronic device or second information supplied from the communication device, and when said plurality of information processing devices can communicate with each other, a pre-selection cycle and a pre-selection size included in a detailed parameter determined by a control device of a first one of the information processing devices, the control device being provided for controlling a communication device of said first one of the information processing devices, being equivalent to a pre-selection cycle and a pre-selection size of a second one of the information processing devices, said first one and said second one being different from each other.

According to this arrangement, in order to control the communication device of the first one of the information processing devices, the first one and the second one have an identical pre-selection cycle and an identical pre-selection size. Provided that, for instance, the first one is a slave terminal and the second one is a master terminal, the slave terminal can assign an identical pre-selection cycle and an identical pre-selection size to both the master terminal and the slave terminal.

Note that, an electric power management program can cause the above-mentioned steps to be executed on a computer. Furthermore, this electric power management program can be executed on an arbitrary computer, when the program is stored in a computer-readable storage medium.

A control device, which is for controlling a communication device and an electronic device which performs communication using the communication device, obtains first information from the electronic device and second information from the communication device, and the communication device is controlled in accordance with at least one of the first information and the second information.

According to this arrangement, in addition to the communication device and the electronic device, the control device for controlling the communication device is provided. On this account, the electronic device does not necessary include means specially for the electric power management of the communication, so that the circuitry of the electronic device is relatively simplified. Furthermore, the communication device is controlled by the control device in accordance with at least one of the first information from the electronic device and the second information from the communication device, while keeping a high degree of versatility to be adopted to different types of electronic devices. For this reason, even a multipurpose communication device which can be manufactured at low costs thanks to volume efficiency can realize a low-power-consumption operation most appropriate to the first information from the electronic device or the second information from the communication device.

Furthermore, at least one of the first information and the second information is preferably real-time information which is updated when necessary. With this, the control device can control the communication device in a manner most appropriate to a current state.

Furthermore, the first information preferably includes a request from an application which causes the electronic device to operate. With this, the control device can subject the communication device to a control for the low-power-consumption operation most appropriate to the requests of performing various processes of the application.

Furthermore, the first information preferably includes device information which indicates a current operation state of the electronic device. With this, the control device can subject the communication device to a control for the low-power-consumption operation most appropriate to the device information (e.g. a remaining battery resource of the electronic device).

Furthermore, the second information preferably includes information which indicates a current operation state of the communication device. With this, the control device can subject the communication device to a control for the low-power-consumption operation most appropriate to the information (e.g. an amount of power supply to the communication device) indicating the current operation state of the communication device.

Furthermore, the second information preferably includes channel information indicating a current state of a channel. With this, the control device can subject the communication device to a control for the low-power-consumption operation most appropriate to the channel information.

Furthermore, the control device preferably performs such a control that, in accordance with at least one of the first information and the second information, power consumption of at least one of the electric device and the communication device is substantially minimized. With this, the power consumption of the electronic device or the communication device can be reduced.

Furthermore, the control device of the present invention is preferably arranged in such a manner that, on condition that a request from an application which causes the electronic device to operate is met, power consumption of at least one of the electric device and the communication device is substantially minimized, in accordance with at least one of the first information and the second information. With this, the power consumption of the electronic device or the communication device is reduced, while the request from the application is met.

A control device of the present invention, which is for controlling a communication device and an electronic device which performs communication using the communication device, comprises: a profile selecting section for selecting, from control profiles for controlling the electronic device and the communication device, a control profile which defines an operation to substantially minimize power consumption of at least one of the electronic device and the communication device, in accordance with operation states of the electronic device and the communication device and information including a request to the control device.

Furthermore, the control device of the present invention further includes: an application request interface section which transmits, to the profile selecting section, request information indicating a request from the application causing the electronic device to operate; an electronic device information interface section which transmits, to the profile selecting section, either device type information indicating a type of the electronic device or device information indicating the operation state of the electronic device; and a channel information interface section which transmits, to the profile selecting section, operation state information indicating the operation state of the communication device and channel information regarding a channel, the profile selecting section selecting the control profile, in accordance with sets of information transmitted from the application request interface section, the electronic device information interface section, and the channel information interface section.

According to this arrangement, the control device obtains the request information, the device type information, the device information the operation state information, and the path information, and selects the control profile in accordance with these sets of information. On this account, the control device can select a control profile most appropriate to a low-power-consumption operation corresponding to the request from the application, the type of the electronic device, the operation state of the electronic device, the operation state of the communication device, and the channel state.

Furthermore, the control device of the present invention further comprises: a communication device power management section which transmits, to the communication device, management information regarding power management of the communication device, in accordance with the control profile selected by the profile selecting section; a communication device circuit operation control section which transmits, to the communication device, control information regarding control of a circuit operation of the communication device, in accordance with the control profile selected by the profile selecting section; and an action instructing section which transmits control information with regard to the application causing the electronic device to operate, in accordance with the control profile selected by the profile selecting section.

Furthermore, from a control profile table in which the control profiles determined in advance in accordance with combinations of sets of information which cab be transmitted to the control device, the control profile is uniquely selected by the profile selecting section, in accordance with information actually transmitted to the control device.

According to the arrangement above, the control device selects the control profile with reference to the control profile table. For this reason, the control profile is promptly selected.

Furthermore, the control profile table includes combinations of elements selected from (i) a first information group including at least device type information, request information, and device information and (ii) a second information group including channel information.

According to this arrangement, the control device can promptly select an optimum control profile with reference to the control profile table, only by obtaining the first information group including the device type information, the request information, and the device information and the second information group including the channel information.

Furthermore, the channel information includes information regarding delay spread of the channel.

According to this arrangement, although a circuit for maintaining communication properties on the occasion of multipath interference is generally provided in a BB section, the operation of this circuit can be controlled in accordance with the delay spread, so that an appropriate control profile can be selected.

Furthermore, weighting coefficients are assigned to the respective elements, and the profile selecting section selects the control profile with reference to the weighting coefficients.

According to this arrangement, the control device gives priority to an element having a higher weighting coefficient as compared to an element having a lower weighting coefficient. The control device can therefore select the control profile in accordance with the change of the priorities of the elements.

Furthermore, the weighting coefficients assigned to the respective elements are changed in accordance with a combination pattern of the elements.

According to this arrangement, the weighting coefficients change in line with the change of the combination pattern of the elements, so that the control is carried out in line with the change of the elements, in a subtler manner.

Furthermore, the weighting coefficients are changed in accordance with the application and a remaining battery power level of a battery attached to the electronic device.

According to this arrangement, giving priority to the change of the application and the change of the remaining battery resource, the control device can select the control profile corresponding to the changes.

Furthermore, the communication device is preferably a wireless communication device. Since the wireless communication device consumes relatively great amounts of power, the effect of the power saving by the control device is significant.

Furthermore, the electronic device of the present invention is connected to the control device and controlled by the control device. Also, the communication device of the present invention is connected to the control device and controlled by the control device.

Furthermore, a communication equipment of the present invention includes the above-described control device and the above-described communication device. According to this arrangement, since the communication equipment includes the above-described control device and the above-described communication device, it is possible to reduce the power consumption of a communication device only by connecting the communication equipment with an electronic device. O this occasion, the communication device is controlled by the control device, rather than directly by the electronic device. For this reason, the communication device has a high degree of versatility.

An information processing device of the present invention comprises: the aforesaid control device; an electronic device which provides information to the control device in order to realize the profile selection and is operated by an application controlled in accordance with the control profile; and a communication device which provides information to the control device in order to realize the profile selection and is controlled in accordance with the control profile.

According to this arrangement, even a multipurpose communication device which can be manufactured at low costs thanks to volume efficiency can realize a low-power-consumption operation most appropriate to the first information from the electronic device or the second information from the communication device.

Furthermore, the information processing device of the present invention is preferably arranged such that the communication device is a wireless communication device. Since the wireless communication device consumes relatively great amounts of power, the effect of the power saving by the control device is significant.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. An information processing device, comprising:
a communication device;
an electronic device which executes at least one application; and
a control device which determines a control signal supplied to the communication device, in accordance with first information supplied from the electronic device.

2. The information processing device as defined in claim 1, wherein, the control device determines the control signal, further in accordance with second information supplied from the communication device.

3. The information processing device as defined in claim 1, wherein, the first information includes information which relates to either a state of use of said at least one application or a control mode regarding electric power management determined for each application.

4. The information processing device as defined in claim 2, wherein, the second information includes information regarding a use environment of the communication device.

5. The information processing device as defined in claim 4, wherein, the information regarding the use environment of the communication device is selected from at least one of: power supply information indicating electric power supplied to the communication device; and channel information indicating a current state of a channel.

6. The information processing device as defined in claim 4, wherein, the communication device is a wireless communication device.

7. The information processing device as defined in claim 6, wherein, the information regarding the use environment of the communication device is selected from at least one of: power supply information indicating electric power supplied to the communication device; channel information indicating a current state of a channel; and area information indicating an electric wave environment of the communication device.

8. The information processing device as defined in claim 1, wherein, during a period in which more than one application run, the control device obtains, from each of said more than one application, priority information regarding electric power management, and determines the control signal in accordance with the priority information.

9. The information processing device as defined in claim 4, wherein, the information regarding the use environment of the communication device is fed back to the control device, in accordance with a change of the use environment, and
the control device updates the control signal supplied to the communication device, in accordance with the information being fed back.

10. The information processing device as defined in claim 5, wherein, the power supply information includes remaining battery resource at a time of driving a battery, and
when the remaining battery resource indicates that a remaining battery power is lower than a predetermined level, the control signal supplied to the communication device is determined based primarily on the power supply information.

11. The information processing device as defined in claim 3, wherein, the control mode is selected in accordance with information regarding electric power management, the electric power management being performed by the communication device in response to a request from an application concerning the control mode.

12. The information processing device as defined in claim 1, wherein, the control signal supplied to the communication device is a signal for determining a detailed parameter of the communication device, the detailed parameter at least including transmission output level control, reception sensitivity level control, and power management.

13. The information processing device as defined in claim 12, wherein, by a signal generated in accordance with the power management of the detailed parameter, a power source of at least one of a transmitter circuit and a receiver circuit which are provided in the communication device is controlled.

14. The information processing device as defined in claim 12, wherein, by a signal generated in accordance with the transmission output level control of the detailed parameter, a power amplifier provided in the communication device is controlled.

15. The information processing device as defined in claim 12, wherein, by a signal generated in accordance with a the reception sensitivity level control of the detailed parameter, a low-noise amplifier provided in the communication device is controlled.

16. The information processing device as defined in claim 12, wherein, apart from information such as a state of use and a control mode, each application has a command for determining, in an interruptive manner, a timing at which an electric power management is performed, and
the control device determines the detailed parameter in accordance with the command.

17. The information processing device as defined in claim 16, wherein, the command includes at least one of:
a command concerning switch-on/off of power supply to the communication device; and a command concerning a switch of a transmission output level and/or a switch of a reception sensitivity level.

18. An information processing device, comprising:
a communication device;
an electronic device which executes at least one application; and
a control device which determines a control signal supplied to the communication device, in accordance with second information supplied from the communication device.

19. The information processing device as defined in claim 18, wherein, the control device determines the control signal, further in accordance with first information supplied from the electronic device.

20. The information processing device as defined in claim 19, wherein, the first information includes information which relates to either a state of use of said at least one application or a control mode regarding electric power management determined for each application.

21. The information processing device as defined in claim 18, wherein, the second information includes information regarding a use environment of the communication device.

22. The information processing device as defined in claim 21, wherein, the information regarding the use environment of the communication device is selected from at least one of: power supply information indicating electric power supplied to the communication device; and channel information indicating a current state of a channel.

23. The information processing device as defined in claim 21, wherein, the communication device is a wireless communication device.

24. The information processing device as defined in claim 23, wherein, the information regarding the use environment of the communication device is selected from at least one of: power supply information indicating electric power supplied to the communication device; channel information indicating a current state of a channel; and area information indicating an electric wave environment of the communication device.

25. The information processing device as defined in claim 18, wherein, during a period in which more than one application run, the control device obtains, from each of said more than one application, priority information regarding electric power management, and determines the control signal in accordance with the priority information.

26. The information processing device as defined in claim 21, wherein, the information regarding the use environment of the communication device is fed back to the control device, in accordance with a change of the use environment, and
the control device updates the control signal supplied to the communication device, in accordance with the information being fed back.

27. The information processing device as defined in claim 22, wherein, the power supply information includes remaining battery resource at a time of driving a battery, and
when the remaining battery resource indicates that a remaining battery power is lower than a predetermined level, the control signal supplied to the communication device is determined based primarily on the power supply information.

28. The information processing device as defined in claim 20, wherein, the control mode is selected in accordance with information regarding the electric power management, the electric power management being performed by the communication device in response to a request from an application concerning the control mode.

29. The information processing device as defined in claim 18, wherein, the control signal supplied to the communication device is a signal for determining a detailed parameter of the communication device, the detailed parameter at least including transmission output level control, reception sensitivity level control, and power management.

30. The information processing device as defined in claim 29, wherein, by a signal generated in accordance with the power management of the detailed parameter, a power source of at least one of a transmitter circuit and a receiver circuit which are provided in the communication device is controlled.

31. The information processing device as defined in claim 29, wherein, by a signal generated in accordance with the transmission output level control of the detailed parameter, a power amplifier provided in the communication device is controlled.

32. The information processing device as defined in claim 29, wherein, by a signal generated in accordance with a the reception sensitivity level control of the detailed parameter, a low-noise amplifier provided in the communication device is controlled.

33. The information processing device as defined in claim 29, wherein, apart from information such as a state of use and a control mode, each application has a command for determining, in an interruptive manner, a timing at which an electric power management is performed, and
the control device determines the detailed parameter in accordance with the command.

34. The information processing device as defined in claim 33, wherein, the command includes at least one of:
a command concerning switch-on/off of power supply to the communication device; and a command concerning a switch of a transmission output level and/or a reception sensitivity level.

35. An information processing device, including:
a communication device;
an electronic device which executes at least one application, using the communication device; and
a control device which controls the communication device,
the information processing device further comprising:
an application interface which supplies, to the control device, at least one of (i) information regarding a state of use of said at least one application and (ii) information regarding a control mode concerning an electric power management determined for each application; and
a system interface through which information regarding a use environment of the communication device is inputted to the control device, and
in accordance with an input from the application interface, the control device determining an intermediate process signal indicating a method of controlling the communication device in each period, while, in accordance with the intermediate process signal and an input from the system interface, a detailed parameter for controlling the communication device being determined.

36. An information processing system, comprising a plurality of information processing devices each including:
a communication device;
an electronic device which executes at least one application; and
a control device which determines a control signal supplied to the communication device, in accordance with either first information supplied from the electronic device or second information supplied from the communication device, and
when said plurality of information processing devices can communicate with each other, a pre-selection cycle and a pre-selection size included in a detailed parameter determined by a control device of a first one of the information processing devices, the control device being provided for controlling a communication device of said first one of the information processing devices, being equivalent to a pre-selection cycle and a pre-selection size of a second one of the information processing devices, said first one and said second one being different from each other.

37. A method of controlling electric power regarding an information processing device which includes a communication device and an electronic device which executes at least one application that performs communication using the communication device,
the method comprising the steps of:
determining an intermediate process signal indicating a method of controlling the communication device in each period, in accordance with at least one of (i) information regarding a state of use of said at least one application and (ii) information regarding a control mode concerning electric power management determined for each application; and
controlling the communication device, in accordance with the intermediate process signal and information regarding a use environment of the communication device.

38. A method of controlling electric power of an information processing device which includes a communication device and can execute at least one application,
the method comprising:
a first step of selecting, among applications in operation, an operation mode of an application which has the highest priority, as a method of controlling the communication device during a period of an operation of the application which has the highest priority; and
a second step of outputting, to the communication device, a detailed parameter including the operation mode, a transmission output level, and a reception sensitivity level which correspond to the control method determined in the first step, in accordance with the control method determined in the first step and information including at least a channel state.

39. A control device for controlling a communication device and an electronic device which performs communication using the communication device,
the communication device obtaining first information and second information from the communication device, so that the communication device is controlled in accordance with at least one of the first information and the second information.

40. The control device as defined in claim 39 wherein, at least one of the first information and the second information is real-time information which is updated when necessary.

41. The control device as defined in claim 39, wherein, the first information includes a request from an application which causes the electronic device to operate.

42. The control device as defined in claim 39, wherein, the first information includes device information which indicates a current operation state of the electronic device.

43. The control device as defined in claim 39, wherein, the second information includes information which indicates a current operation state of the communication device.

44. The control device as defined in claim 39, wherein, the second information includes channel information indicating a current state of a channel.

45. The control device as defined in claim 39, wherein, in accordance with at least one of the first information and the second information, power consumption of at least one of the electric device and the communication device is substantially minimized.

46. The control device as defined in claim 39, wherein, on condition that a request from an application which causes the electronic device to operate is met, power consumption of at least one of the electric device and the communication device is substantially minimized, in accordance with at least one of the first information and the second information.

47. A control device for controlling a communication device and an electronic device which performs communication using the communication device,
the control device comprising:
a profile selecting section for selecting, from control profiles for controlling the electronic device and the communication device, a control profile which defines an operation to substantially minimize power consumption of at least one of the electronic device and the communication device, in accordance with operation states of the electronic device and the communication device and information including a request to the control device.

48. A control device as defined in claim 47, further comprising:
an application request interface section which transmits, to the profile selecting section, request information indicating a request from the application causing the electronic device to operate;
an electronic device information interface section which transmits, to the profile selecting section, either device type information indicating a type of the electronic device or device information indicating the operation state of the electronic device; and
a channel information interface section which transmits, to the profile selecting section, operation state information indicating the operation state of the communication device and channel information regarding a channel,
the profile selecting section selecting the control profile, in accordance with sets of information transmitted from the application request interface section, the electronic device information interface section, and the channel information interface section.

49. The control device as defined in claim 47, further comprising:
a communication device power management section which transmits, to the communication device, management information regarding power management of the communication device, in accordance with the control profile selected by the profile selecting section;
a communication device circuit operation control section which transmits, to the communication device, control information regarding control of a circuit operation of the communication device, in accordance with the control profile selected by the profile selecting section; and
an action instructing section which transmits control information with regard to the application causing the electronic device to operate, in accordance with the control profile selected by the profile selecting section.

50. The control device as defined in claim 47, wherein, from a control profile table in which the control profiles determined in advance in accordance with combinations of sets of information which cab be transmitted to the control device, the control profile is uniquely selected by the profile selecting section, in accordance with information actually transmitted to the control device.

51. The control device as defined in claim 50, wherein, the control profile table includes combinations of elements selected from (i) a first information group including at least device type information, request information, and device information and (ii) a second information group including channel information.

52. The control device as defined in claim 44, wherein, the channel information includes information regarding delay spread of the channel.

53. The control device as defined in claim 51, wherein, weighting coefficients are assigned to the respective elements, and the profile selecting section selects the control profile with reference to the weighting coefficients.

54. The control device as defined in claim 53, wherein, the weighting coefficients assigned to the respective elements are changed in accordance with a combination pattern of the elements.

55. The control device as defined in claim 53, wherein, the weighting coefficients are changed in accordance with the application and a remaining battery power level of a battery attached to the electronic device.

56. The control device as defined in claim 39, wherein, the communication device is a wireless communication device.

57. An electronic device which is connected to a communication device via a control device and carries out communication using the communication device,
the electronic device being controlled by the control device, in accordance with at least one of first information from the electronic device and second information from the communication device.

58. A communication device which is connected to an electronic device via a control device and carries out communication in response to a request from the electronic device,
the communication device being controlled by the control device, in accordance with at least one of first information from the electronic device and second information from the communication device.

59. A communication equipment, comprising a communication device and a control device which controls the communication device,
the control device controlling the communication device in accordance with at least one of (i) first information from an electronic device which carries out communication using the communication device and (ii) second information from the communication device.

60. An information processing device, comprising:
a communication device;
an electronic device which performs communication using the communication device; and
a control device which controls the communication device and the electronic device,
the control device including a profile selecting section which selects, from control profiles for controlling the electronic device and the communication device, a control profile which defines an operation to substantially minimize power consumption of at least one of the electronic device and the communication device, in accordance with (i) operation states of the electronic device and the communication device and (ii) information including a request to the control device,
the electronic device providing, to the control device, information for selecting the control profile, and the electronic device being operated by an application controlled in line with the control profile; and
the communication device providing, to the control device, information for selecting the control profile, and the communication device being controlled in accordance with the selected control profile.

61. The information processing device as defined in claim 60, wherein, the communication device is a wireless communication device.

62. An electric power management program which causes a computer to execute a method of managing electric power of an information processing device including a communication device and an electronic device which executes at least one application that performs communication using the communication device,
the method including the steps of:
determining an intermediate process signal indicating a method of controlling the communication device in each period, in accordance with at least one of (i) information regarding a state of use of said at least one application and (ii) information regarding a control mode concerning electric power management determined for each application; and
controlling the communication device, in accordance with the intermediate process signal and information regarding a use environment of the communication device.

63. An electric power management program which causes a computer to execute a method of managing electric power of an information processing device which includes a communication device and can execute at least one application,
the method comprising:
a first step of selecting, among applications in operation, an operation mode of an application which has the highest priority, as a method of controlling the communication device during a period of an operation of the application which has the highest priority; and
a second step of outputting, to the communication device, a detailed parameter including the operation mode, a transmission output level, and a reception sensitivity level which correspond to the control method determined in the first step, in accordance with the control method determined in the first step and information including at least a channel state.

64. A computer-readable storage medium storing an electric power management program which causes a computer to execute a method of managing electric power of an information processing device including a communication device and an electronic device which executes at least one application that performs communication using the communication device,
the method including the steps of:
determining an intermediate process signal indicating a method of controlling the communication device in each period, in accordance with at least one of (i) information regarding a state of use of said at least one application and (ii) information regarding a control mode concerning electric power management determined for each application; and
controlling the communication device, in accordance with the intermediate process signal and information regarding a use environment of the communication device.

65. A computer-readable storage medium storing an electric power management program which causes a computer to execute a method of managing electric power of an information processing device which includes a communication device and can execute at least one application,
the method comprising:
a first step of selecting, among applications in operation, an operation mode of an application which has the highest priority, as a method of controlling the communication device during a period of an operation of the application which has the highest priority; and
a second step of outputting, to the communication device, a detailed parameter including the operation mode, a transmission output level, and a reception sensitivity level which correspond to the control method determined in the first step, in accordance with the control method determined in the first step and information including at least a channel state.
